(19) United States
(12) Patent Application Publication
(10) Pub. No.: US 2026/0040328 A1
(43) Pub. Date: Feb. 5, 2026

(54) USER EQUIPMENT AND METHODS

(71) Applicant: SHARP KABUSHIKI KAISHA, Sakai City, Osaka (JP)

(72) Inventors: TOSHIZO NOGAMI, Sakai City, Osaka (JP); HIROKI TAKAHASHI, Sakai City, Osaka (JP); KOZUE YOKOMAKURA, Sakai City, Osaka (JP); Makoto KITAHARA, Sakai City, Osaka (JP)

(21) Appl. No.: 18/997,273

(22) PCT Filed: Jul. 25, 2023
(86) PCT No.: PCT/JP2023/027885

§ 371 Date: Jan. 21, 2025

(30) Foreign Application Priority Data
Jul. 26, 2022 (JP) 2022-118513

(51) Int. Cl. H04W 72/25; H04L 5/00; H04W 64/00

(52) U.S. Cl. CPC H04W 72/25; H04L 5/0048; H04W 64/00

(57) ABSTRACT

A user equipment (UE) is described. The UE may comprise higher layer processing circuitry configured to receive SystemInformationBlockTypeXX (SL PRS related System Information Block) from a base station. The UE may also comprise transmission circuitry configured to perform a transmission of sidelink positioning reference signal (SL-PRS). When the UE is in-coverage for the transmission of the SL-PRS, the UE may perform a first procedure of the transmission of the SL-PRS according to SystemInformationBlockTypeXX. When out-of-coverage for the transmission of the SL-PRS, the UE may perform a second procedure of the transmission of the SL-PRS according to pre-configuration.

### TECHNICAL FIELD

The present invention relates to a user equipment and a method.

### BACKGROUND ART

In the 3rd Generation Partnership Project (3GPP), a radio access method and a radio network for cellular mobile communications (hereinafter, referred to as Long Term Evolution, or Evolved Universal Terrestrial Radio Access) have been studied. In LTE (Long Term Evolution), a base station device is also referred to as an evolved NodeB (eNodeB), and a terminal device is also referred to as a User Equipment (UE). LTE is a cellular communication system in which multiple areas are deployed in a cellular structure, with each of the multiple areas being covered by a base station device. A single base station device may manage multiple cells. Evolved Universal Terrestrial Radio Access is also referred as E-UTRA.

In the 3GPP, the next generation standard (New Radio: NR) has been studied in order to make a proposal to the International-Mobile-Telecommunication-2020 (IMT-2020) which is a standard for the next generation mobile communication system defined by the International Telecommunications Union (ITU). NR has been expected to satisfy a requirement considering three scenarios of enhanced Mobile BroadBand (eMBB), massive Machine Type Communication (mMTC), and Ultra Reliable and Low Latency Communication (URLLC), in a single technology framework.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a conceptual diagram of a wireless communication system;

FIG. 2 is an example showing the relationship between subcarrier-spacing configuration u, the number of OFDM symbols per slot N^{slot}_{symb}, and the CP configuration;

FIG. 3 is a diagram showing an example of a method of configuring a resource grid;

FIG. 4 is a diagram showing a configuration example of a resource grid 3001;

FIG. 5 is a schematic block diagram showing a configuration example of the base station device;

FIG. 6 is a schematic block diagram showing a configuration example of the terminal device;

FIG. 7 is a diagram showing a configuration example of an SS/PBCH block;

FIG. 8 is a diagram showing an example of the monitoring occasion of the search-space-set;

FIG. 9 is another conceptual diagram of a wireless communication system;

FIG. 10 shows procedures of sidelink RRC reconfiguration;

FIG. 11 shows the table for SLSS parameter determination;

FIG. 12 shows an example of sub-channel structure for sidelink transmissions;

FIG. 13 shows an example of resource pool for sidelink transmissions;

FIG. 14 is a conceptual diagram of a positioning system using sidelink signal;

FIG. 15 is a conceptual diagram of a positioning system using sidelink signal;

FIG. 16 is a conceptual diagram of a positioning system using sidelink signal;

FIG. 17 shows an example of a method for a UE #1;

FIG. 18 shows an example of a method for a UE #2.

### DESCRIPTION OF EMBODIMENTS

A user equipment (UE) is described. The UE may comprise higher layer processing circuitry configured to receive SystemInformationBlockTypeXX (SL PRS related System Information Block) from a base station. The UE may also comprise transmission circuitry configured to perform a transmission of sidelink positioning reference signal (SL-PRS). When the UE is in-coverage for the transmission of the SL-PRS, the UE may perform a first procedure of the transmission of the SL-PRS according to SystemInformationBlockTypeXX. When out-of-coverage for the transmission of the SL-PRS, the UE may perform a second procedure of the transmission of the SL-PRS according to pre-configuration.

In the first procedure, a resource for the transmission of SL-PRS may be selected from a first resource pool which is indicated by the SystemInformationBlockTypeXX. In the second procedure, the resource for the transmission of SL-PRS may be selected from a second resource pool which is indicated by the pre-configuration.

In the first procedure, whether to perform the transmission of SL-PRS in the first resource pool further may depend on a sensing result on the first resource pool.

In the second procedure, whether to perform the transmission of SL-PRS in the second resource pool further may depend on a sensing result on the second resource pool.

In the second procedure, whether to perform the transmission of SL-PRS in the second resource pool further may depend on whether to detect SidelinkSystemInformationBlockTypeXX from another UE.

The higher-layer processing circuitry may be further configured to receive dedicated RRC configuration from a base station. In the first procedure, when the dedicated RRC configuration is acquired, a resource for the transmission of SL-PRS may be selected from a third resource pool which is indicated by the dedicated RRC configuration (and the first resource pool is not used).

In the first procedure, whether to perform the transmission of SL-PRS may depend on whether a list of system information described in SystemInformationBlockType1 includes the SystemInformationBlockTypeXX.

A user equipment (UE) is described. The UE may comprise higher layer processing circuitry configured to receive SystemInformationBlockTypeXX (SL PRS related System Information Block) from a base station. The UE may also comprise reception circuitry configured to perform a measurement of sidelink positioning reference signal (SL-PRS). When the UE is in-coverage for the measurement of the SL-PRS, the UE may perform a first procedure of the measurement of the SL-PRS according to SystemInformationBlockTypeXX. When out-of-coverage for the measurement of the SL-PRS, the UE may perform a second procedure of the measurement of the SL-PRS according to pre-configuration.

A method for a user equipment (UE) is described. The method may comprise receiving SystemInformationBlockTypeXX (SL PRS related System Information Block) from a base station. The method may also comprise performing a transmission of sidelink positioning reference signal (SL-PRS). When the UE is in-coverage for the transmission of the SL-PRS, the UE may perform a first procedure of the transmission of the SL-PRS according to SystemInformationBlockTypeXX. When out-of-coverage for the transmission of the SL-PRS, the UE may perform a second procedure of the transmission of the SL-PRS according to pre-configuration.

floor (CX) may be a floor function for real number CX. For example, floor (CX) may be a function that provides the largest integer within a range that does not exceed the real number CX. ceil (DX) may be a ceiling function to a real number DX. For example, ceil (DX) may be a function that provides the smallest integer within the range not less than the real number DX. mod (EX, FX) may be a function that provides the remainder obtained by dividing EX by FX. mod (EX, FX) may be a function that provides a value which corresponds to the remainder of dividing EX by FX. It is exp (GX)=e\hat{ }GX. Here, e is Napier number. (HX)\hat{ }(IX) indicates IX to the power of HX.

In a wireless communication system according to one aspect of the present embodiment, at least OFDM (Orthogonal Frequency Division Multiplex) is used. An OFDM symbol is a unit of time domain of the OFDM. The OFDM symbol includes at least one or more subcarriers. An OFDM symbol is converted to a time-continuous signal in baseband signal generation. In downlink, at least CP-OFDM (Cyclic Prefix-Orthogonal Frequency Division Multiplex) is used. In uplink, either CP-OFDM or DFT-s-OFDM (Discrete Fourier Transform-spread-Orthogonal Frequency Division Multiplex) is used. DFT-s-OFDM may be given by applying transform precoding to CP-OFDM. CP-OFDM is OFDM using CP (Cyclic Prefix).

The OFDM symbol may be a designation including a CP added to the OFDM symbol. That is, an OFDM symbol may be configured to include the OFDM symbol and a CP added to the OFDM symbol.

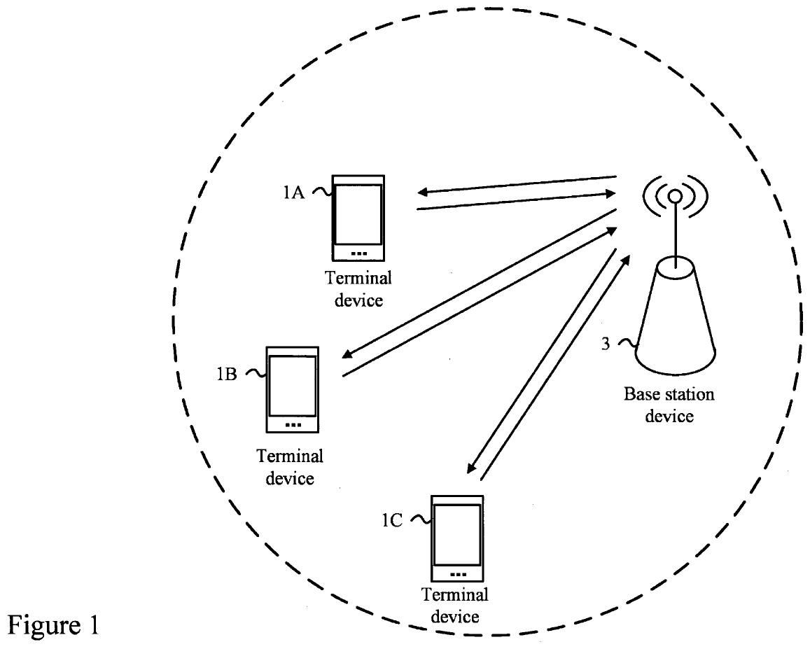

FIG. 1 is a conceptual diagram of a wireless communication system. In FIG. 1, the wireless communication system includes at least terminal device 1A to 1C and a base station device 3 (BS #3: Base station #3). Hereinafter, the terminal devices 1A to 1C are also referred to as a terminal device 1 (UE #1: User Equipment #1).

The base station device 3 may be configured to include one or more transmission devices (or transmission points, transmission devices, reception devices, transmission points, reception points). When the base station device 3 is configured by a plurality of transmission devices, each of the plurality of transmission devices may be arranged at a different position.

The base station device 3 may provide one or more serving cells. A serving cell may be defined as a set of resources used for wireless communication. A serving cell is also referred to as a cell.

A serving cell may be configured to include at least one downlink component carrier (downlink carrier) and/or one uplink component carrier (uplink carrier). A serving cell may be configured to include at least two or more downlink component carriers and/or two or more uplink component carriers. A downlink component carrier and an uplink component carrier are also referred to as component carriers (carriers). The uplink component carrier can be used for sidelink communication.

For example, one resource grid may be provided for one component carrier. For example, one resource grid may be provided for one component carrier and a subcarrier-spacing configuration u. A subcarrier-spacing configuration u is also referred to as numerology. A resource grid includes N^{size, u}_{grid, x}N^{RB}_{sc} subcarriers. The resource grid starts from a common resource block with index N^{start, u}_{grid}. The common resource block with the index N^{start, u}_{grid} is also referred to as a reference point of the resource grid. The resource grid includes N^{subframe, u}_{symb} OFDM symbols. The subscript x indicates the transmission direction and indicates either downlink or uplink. One resource grid is provided for an antenna port p, a subcarrier-spacing configuration u, and a transmission direction x. The resource grid may be applied to downlink, uplink and/or sidelink.

Resource grid is also referred to as carrier.

N^{size, u}_{grid, x} and N^{start, u}_{grid} are given based at least on an RRC parameter (e.g. referred to as RRC parameter CarrierBandwidth). The RRC parameter is used to define one or more SCS (SubCarrier-Spacing) specific carriers. One resource grid corresponds to one SCS specific carrier. One component carrier may comprise one or more SCS specific carriers. The SCS specific carrier may be included in a system information block (SIB). For each SCS specific carrier, a subcarrier-spacing configuration u may be provided.

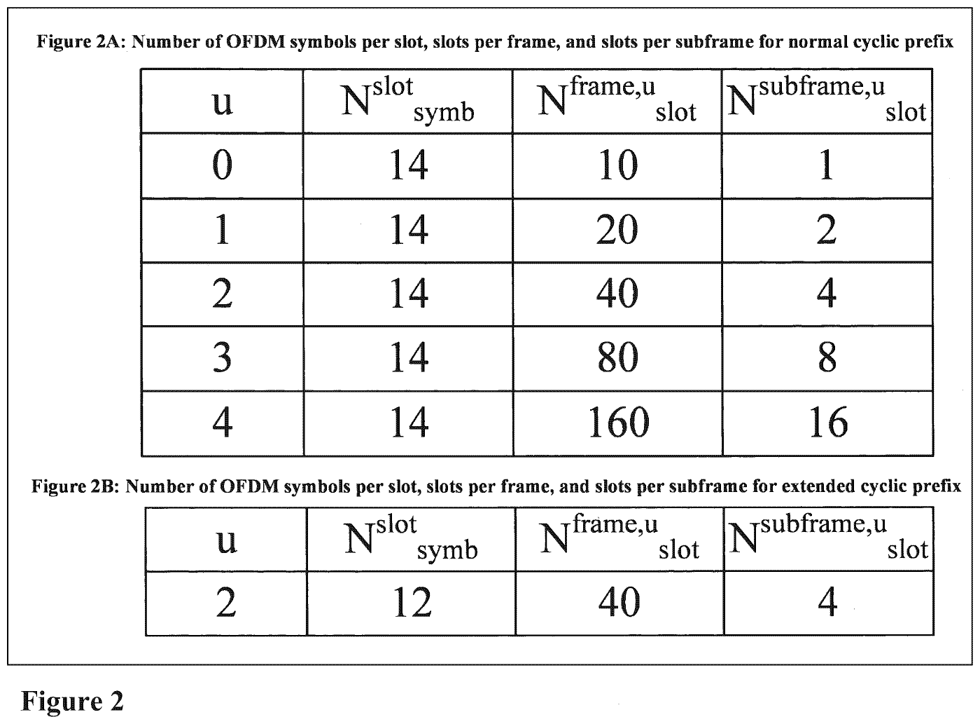

FIG. 2 is an example showing the relationship between subcarrier-spacing configuration u, the number of OFDM symbols per slot N^{slot}_{symb}, and the CP configuration. In FIG. 2A, for example, when the subcarrier-spacing configuration u is set to 2 and the CP configuration is set to normal CP (normal cyclic prefix), N^{slot}_{symb}=14, N^{frame, u}ₛₗₒₜ=40, N^{subframe, u}ₛₗₒₜ=4. Further, in FIG. 2B, for example, when the subcarrier-spacing configuration u is set to 2 and the CP configuration is set to an extended CP (extended cyclic prefix), N^{slot}_{symb}=12, N^{frame, u}ₛₗₒₜ=40, N^{subframe, u}ₛₗₒₜ=4. The subcarrier-spacing configuration u may be applied to downlink, uplink and/or sidelink.

In the wireless communication system, a time unit T_{c} may be used to represent the length of the time domain. The time unit T_{c} is T_{c}=1/(dfₘₐₓ*N_{f}). It is dfₘₐₓ=480 kHz. It is N_{f}=4096. The constant k is k=dfₘₐₓ*N_{f}/(df_{ref}N_{f,ref})=64. df_{ref} is 15 kHz. N_{f}, ref is 2048.

Transmission of signals in the downlink and/or transmission of signals in the uplink and/or transmission of signals in the sidelink may be organized into radio frames (system frames, frames) of length T_{f}. It is T_{f}=(dfₘₐₓ N_{f}/100)*Tₛ=10 ms. One radio frame is configured to include ten subframes. The subframe length is T_{sf}=(dfₘₐₓN_{f}/1000) Tₛ=1 ms. The number of OFDM symbols per subframe is N^{subframe,u}_{symb}=N^{slot}_{symb}N^{subframe, u}ₛₗₒₜ.

For a subcarrier-spacing configuration u, the number of slots included in a subframe and indexes may be given. For example, slot index n^{u}ₛ may be given in ascending order with an integer value ranging from 0 to N^{subframe,u}_{symb}−1 in a subframe. For subcarrier-spacing configuration u, the number of slots included in a radio frame and indexes of slots included in the radio frame may be given. Also, the slot index n^{u}_{s, f} may be given in ascending order with an integer value ranging from 0 to N^{frame,u}ₛₗₒₜ−1 in the radio frame. Consecutive N^{slot}_{symb} OFDM symbols may be included in one slot. It is N^{slot}_{symb}=14.

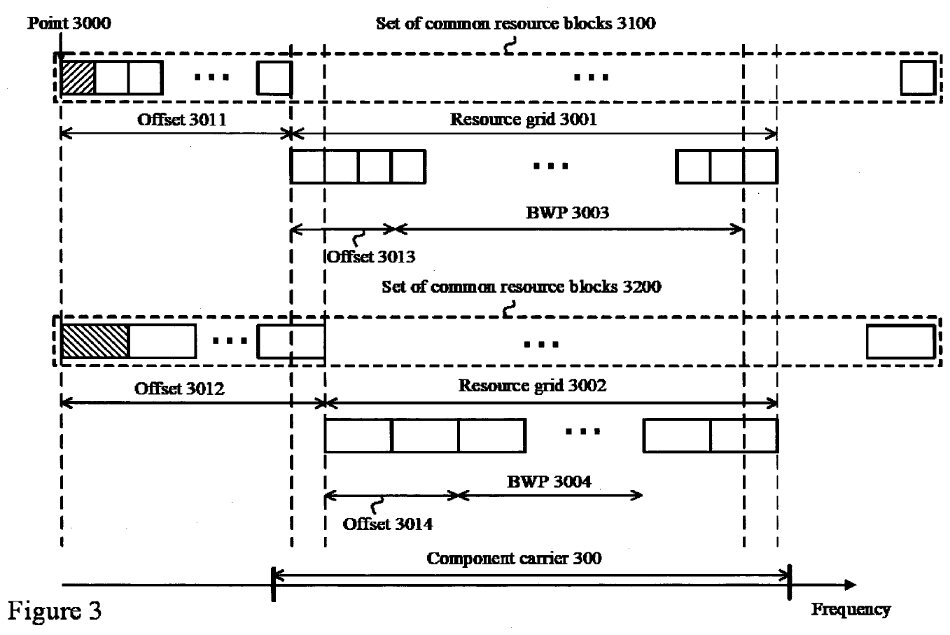

FIG. 3 is a diagram showing an example of a method of configuring a resource grid. The horizontal axis in FIG. 3 indicates frequency domain. FIG. 3 shows a configuration example of a resource grid of subcarrier-spacing configuration u=u₁ in the component carrier 300 and a configuration example of a resource grid of subcarrier-spacing configuration u=u₂ in a component carrier. One or more subcarrier-spacing configuration may be set for a component carrier. Although it is assumed in FIG. 3 that u₁=u₂−1, various aspects of this embodiment are not limited to the condition of u₁=u₂−1.

The component carrier 300 is a band having a predetermined width in the frequency domain.

Point 3000 is an identifier for identifying a subcarrier. Point 3000 is also referred to as point A. The common resource block (CRB) set 3100 is a set of common resource blocks for the subcarrier-spacing configuration u₁.

Among the common resource block-set 3100, the common resource block including the point 3000 (the block indicated by the upper right diagonal line in FIG. 3) is also referred to as a reference point of the common resource block-set 3100. The reference point of the common resource block-set 3100 may be a common resource block with index 0 in the common resource block-set 3100.

The offset 3011 is an offset from the reference point of the common resource block-set 3100 to the reference point of the resource grid 3001. The offset 3011 is indicated by the number of common resource blocks which is relative to the subcarrier-spacing configuration u₁. The resource grid 3001 includes N^{size,u}_{grid1,x} common resource blocks starting from the reference point of the resource grid 3001.

The offset 3013 is an offset from the reference point of the resource grid 3001 to the reference point (N^{start,u}_{BWP,i1}) of the BWP (BandWidth Part) 3003 of the index i1.

Common resource block-set 3200 is a set of common resource blocks with respect to subcarrier-spacing configuration u₂.

A common resource block including the point 3000 (a block indicated by a upper left diagonal line in FIG. 3) in the common resource block-set 3200 is also referred to as a reference point of the common resource block-set 3200. The reference point of the common resource block-set 3200 may be a common resource block with index 0 in the common resource block-set 3200.

The offset 3012 is an offset from the reference point of the common resource block-set 3200 to the reference point of the resource grid 3002. The offset 3012 is indicated by the number of common resource blocks for subcarrier-spacing configuration u=u₂. The resource grid 3002 includes N^{size,u}_{grid2,x} common resource blocks starting from the reference point of the resource grid 3002.

The offset 3014 is an offset from the reference point of the resource grid 3002 to the reference point (N^{start,u}_{BWP,i2}) of the BWP 3004 with index i₂.

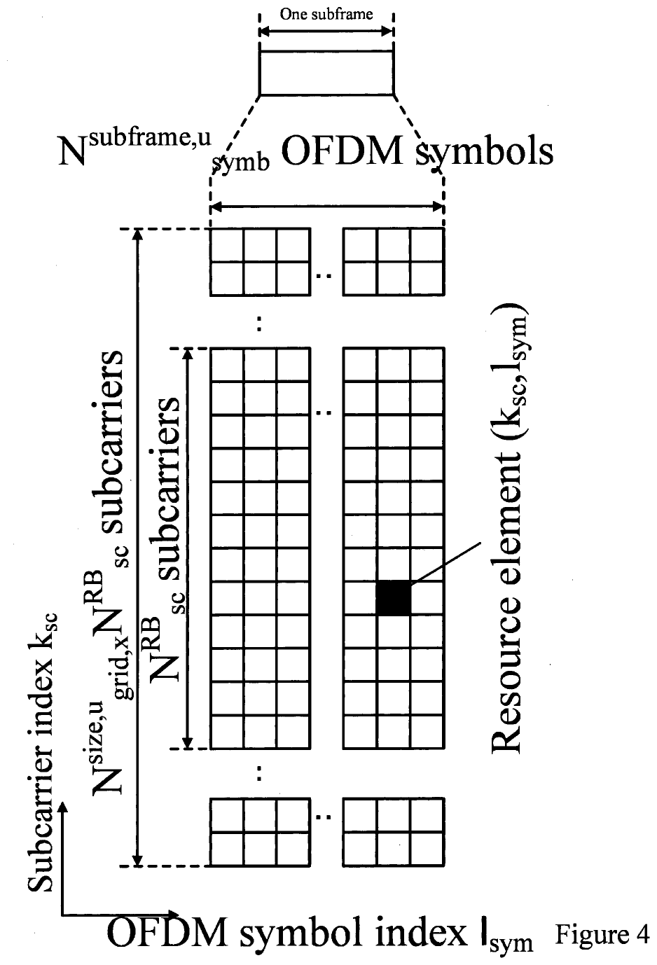

FIG. 4 is a diagram showing a configuration example of a resource grid 3001. In the resource grid of FIG. 4, the horizontal axis indicates OFDM symbol index 1_{sym}, and the vertical axis indicates the subcarrier index k_{sc}. The resource grid 3001 includes N^{size,u}_{grid1,x}N^{RB}_{sc} subcarriers, and includes N^{subframes,u}_{symb} OFDM symbols. A resource specified by the subcarrier index k_{sc} and the OFDM symbol index 1_{sym} in a resource grid is also referred to as a resource element (RE).

A resource block (RB) includes N^{RB}_{sc} consecutive subcarriers. A resource block is a generic name of a common resource block, a physical resource block (PRB), and a virtual resource block (VRB). It is N^{RB}_{sc}=12.

A resource block unit is a set of resources that corresponds to one OFDM symbol in one resource block. That is, one resource block unit includes 12 resource elements which corresponds to one OFDM symbol in one resource block.

Common resource blocks for a subcarrier-spacing configuration u are indexed in ascending order from 0 in the frequency domain in a common resource block-set. The common resource block with index 0 for the subcarrier-spacing configuration u includes (or collides with, matches) the point 3000. The index n^{u}_{CRB} of the common resource block with respect to the subcarrier-spacing configuration u satisfies the relationship of n^{u}_{CRB}=ceil (k_{sc}/N^{RB}_{sc}). The subcarrier with k_{sc}=0 is a subcarrier with the same center frequency as the center frequency of the subcarrier which corresponds to the point 3000.

Physical resource blocks for a subcarrier-spacing configuration u are indexed in ascending order from 0 in the frequency domain in a BWP. The index n^{u}_{PRB} of the physical resource block with respect to the subcarrier-spacing configuration u satisfies the relationship of n^{u}_{CRB}=n^{u}_{PB}+N^{start,u}_{BWP,i}. The N^{start,u}_{BWP,i} indicates the reference point of BWP with index i.

A BWP is defined as a subset of common resource blocks included in the resource grid. The BWP includes N^{size, u}_{BWP,i} common resource blocks starting from the reference points N^{start,u}_{BWP,i}. A BWP for the downlink component carrier is also referred to as a downlink BWP. A BWP for the uplink component carrier is also referred to as an uplink BWP. A BWP for the sidelink is also referred to as a sidelink BWP.

An antenna port is defined such that the channel over which a symbol on the antenna port is conveyed can be inferred from the channel over which another symbol on the same antenna port is conveyed. For example, the channel may correspond to a physical channel. For example, the symbols may correspond to OFDM symbols. For example, the symbols may correspond to resource block units. For example, the symbols may correspond to resource elements.

Two antenna ports are said to be QCL (Quasi Co-Located) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

Carrier aggregation may be communication using a plurality of aggregated serving cells. Carrier aggregation may be communication using a plurality of aggregated component carriers. Carrier aggregation may be communication using a plurality of aggregated downlink component carriers. Carrier aggregation may be communication using a plurality of aggregated uplink component carriers.

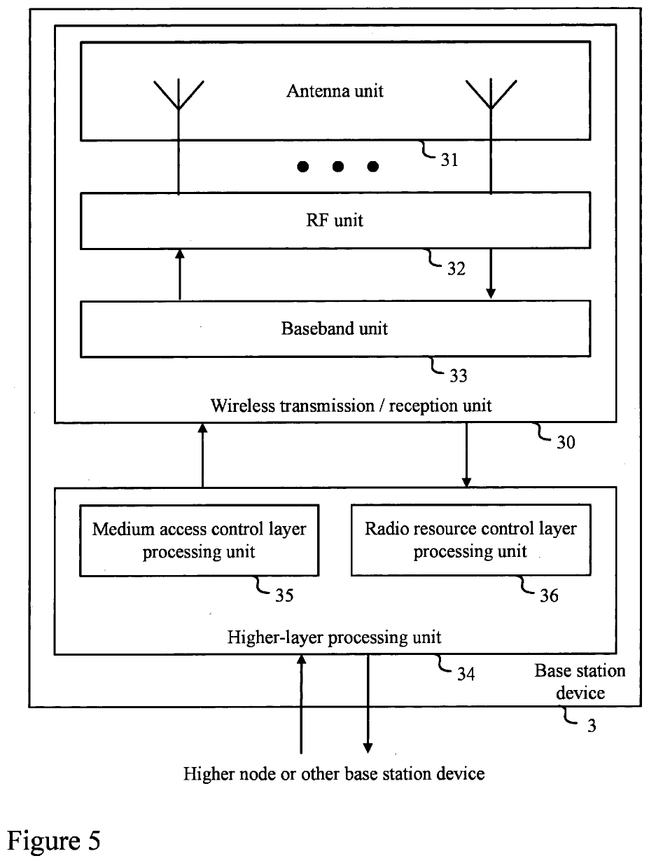

FIG. 5 is a schematic block diagram showing a configuration example of the base station device 3. As shown in FIG. 5, the base station device 3 includes at least a part or all of the wireless transmission/reception unit (physical layer processing unit) 30 and the higher-layer processing unit 34. The wireless transmission/reception unit 30 includes at least a part or all of the antenna unit 31, the RF unit 32 (Radio Frequency unit 32), and the baseband unit 33. The higher-layer processing unit 34 includes at least a part or all of the medium access control layer processing unit 35 and the radio resource control (RRC) layer processing unit 36.

The wireless transmission/reception unit 30 includes at least a part of or all of a wireless transmission unit 30a and a wireless reception unit 30b. The configuration of the baseband unit 33 included in the wireless transmission unit 30a and the configuration of the baseband unit 33 included in the wireless reception unit 30b may be the same or different. The configuration of the RF unit 32 included in the wireless transmission unit 30a and the configuration of the RF unit 32 included in the wireless reception unit 30b may be the same or different. The configuration of the antenna unit 31 included in the wireless transmission unit 30a and the configuration of the antenna unit 31 included in the wireless reception unit 30b may be the same or different.

The higher-layer processing unit 34 provides downlink data (a transport block) to the wireless transmission/reception unit 30 (or the wireless transmission unit 30a). The higher-layer processing unit 34 performs processing of a medium access control (MAC) layer, a packet data convergence protocol layer (PDCP layer), a radio link control layer (RLC layer) and/or an RRC layer.

The medium access control layer processing unit 35 included in the higher-layer processing unit 34 performs processing of the MAC layer.

The radio resource control layer processing unit 36 included in the higher-layer processing unit 34 performs the process of the RRC layer. The radio resource control layer processing unit 36 manages various configuration information/parameters (RRC parameters) of the terminal device 1. The radio resource control layer processing unit 36 configures an RRC parameter based on the RRC message received from the terminal device 1.

The wireless transmission/reception unit 30 (or the wireless transmission unit 30a) performs processing such as encoding and modulation. The wireless transmission/reception unit 30 (or the wireless transmission unit 30a) generates a physical signal by encoding and modulating the downlink data. The wireless transmission/reception unit 30 (or the wireless transmission unit 30a) converts OFDM symbols in the physical signal to a baseband signal by conversion to a time-continuous signal. The wireless transmission/reception unit 30 (or the wireless transmission unit 30a) transmits the baseband signal (or the physical signal) to the terminal device 1 via radio frequency. The wireless transmission/reception unit 30 (or the wireless transmission unit 30a) may arrange the baseband signal (or the physical signal) on a component carrier and transmit the baseband signal (or the physical signal) to the terminal device 1.

The wireless transmission/reception unit 30 (or the wireless reception unit 30b) performs processing such as demodulation and decoding. The wireless transmission/reception unit 30 (or the wireless reception unit 30b) separates, demodulates and decodes the received physical signal, and provides the decoded information to the higher-layer processing unit 34. The wireless transmission/reception unit 30 (or the wireless reception unit 30b) may perform the channel access procedure prior to the transmission of the physical signal.

The RF unit 32 demodulates the physical signal received via the antenna unit 31 into a baseband signal (down convert), and/or removes extra frequency components. The RF unit 32 provides the processed analog signal to the baseband unit 33.

The baseband unit 33 converts an analog signal (signals on radio frequency) input from the RF unit 32 into a digital signal (a baseband signal). The baseband unit 33 separates a portion which corresponds to CP (Cyclic Prefix) from the digital signal. The baseband unit 33 performs Fast Fourier Transformation (FFT) on the digital signal from which the CP has been removed. The baseband unit 33 provides the physical signal in the frequency domain.

The baseband unit 33 performs Inverse Fast Fourier Transformation (IFFT) on downlink data to generate an OFDM symbol, adds a CP to the generated OFDM symbol, generates a digital signal (baseband signal), and convert the digital signal into an analog signal. The baseband unit 33 provides the analog signal to the RF unit 32.

The RF unit 32 removes extra frequency components from the analog signal (signals on radio frequency) input from the baseband unit 33, up-converts the analog signal to a radio frequency, and transmits it via the antenna unit 31. The RF unit 32 may have a function of controlling transmission power. The RF unit 32 is also referred to as a transmission power control unit.

At least one or more serving cells (or one or more component carriers, one or more downlink component carriers, one or more uplink component carriers) may be configured for the terminal device 1.

Each of the serving cells set for the terminal device 1 may be any of PCell (Primary cell), PSCell (Primary SCG cell), and SCell (Secondary Cell).

A PCell is a serving cell included in a MCG (Master Cell Group). A PCell is a cell (implemented cell) which performs an initial connection establishment procedure or a connection re-establishment procedure by the terminal device 1.

A PSCell is a serving cell included in a SCG (Secondary Cell Group). A PSCell is a serving cell in which random-access is performed by the terminal device 1 in a reconfiguration procedure with synchronization (Reconfiguration with synchronization).

A SCell may be included in either a MCG or a SCG.

The serving cell group (cell group) is a designation including at least MCG and SCG. The serving cell group may include one or more serving cells (or one or more component carriers). One or more serving cells (or one or more component carriers) included in the serving cell group may be operated by carrier aggregation.

One or more downlink BWPs may be configured for each serving cell (or each downlink component carrier). One or more uplink BWPs may be configured for each serving cell (or each uplink component carrier).

Among the one or more downlink BWPs set for the serving cell (or the downlink component carrier), one downlink BWP may be set as an active downlink BWP (or one downlink BWP may be activated). Among the one or more uplink BWPs set for the serving cell (or the uplink component carrier), one uplink BWP may be set as an active uplink BWP (or one uplink BWP may be activated).

A PDSCH, a PDCCH, a CSI-RS and other physical downlink channels/signals may be received in the active downlink BWP. The terminal device 1 may receive the PDSCH, the PDCCH, and the CSI-RS in the active downlink BWP. Additionally, in some case, the terminal device 1 may receive the CSI-RS or other physical downlink channels/signals (e.g., Positioning RS (PRS)) in the downlink BWP that is not active or in the cell that is not a serving cell. A PUCCH, a PUSCH, an SRS and other physical uplink channels/signals may be sent on the active uplink BWP. The terminal device 1 may transmit the PUCCH, the PUSCH, the SRS and other physical uplink channels/signals in the active uplink BWP. Additionally, in some case, the terminal device 1 may receive the SRS or other physical uplink channels/signals (e.g., SRS for Positioning) in the uplink BWP that is not active or in the cell that is not a serving cell. The active downlink BWP and the active uplink BWP are also referred to as active BWP.

Downlink BWP switching deactivates an active downlink BWP and activates one of inactive downlink BWPs which are other than the active downlink BWP. The downlink BWP switching may be controlled by a BWP field included in a downlink control information. The downlink BWP switching may be controlled based on higher-layer parameters.

Uplink BWP switching is used to deactivate an active uplink BWP and activate any inactive uplink BWP which is other than the active uplink BWP. Uplink BWP switching may be controlled by a BWP field included in a downlink control information. The uplink BWP switching may be controlled based on higher-layer parameters.

Among the one or more downlink BWPs set for the serving cell, two or more downlink BWPs may not be set as active downlink BWPs. For the serving cell, one downlink BWP may be active at a certain time.

Among the one or more uplink BWPs set for the serving cell, two or more uplink BWPs may not be set as active uplink BWPs. For the serving cell, one uplink BWP may be active at a certain time.

The aforementioned procedures for Uplink BWP may be applicable to Sidelink BWP.

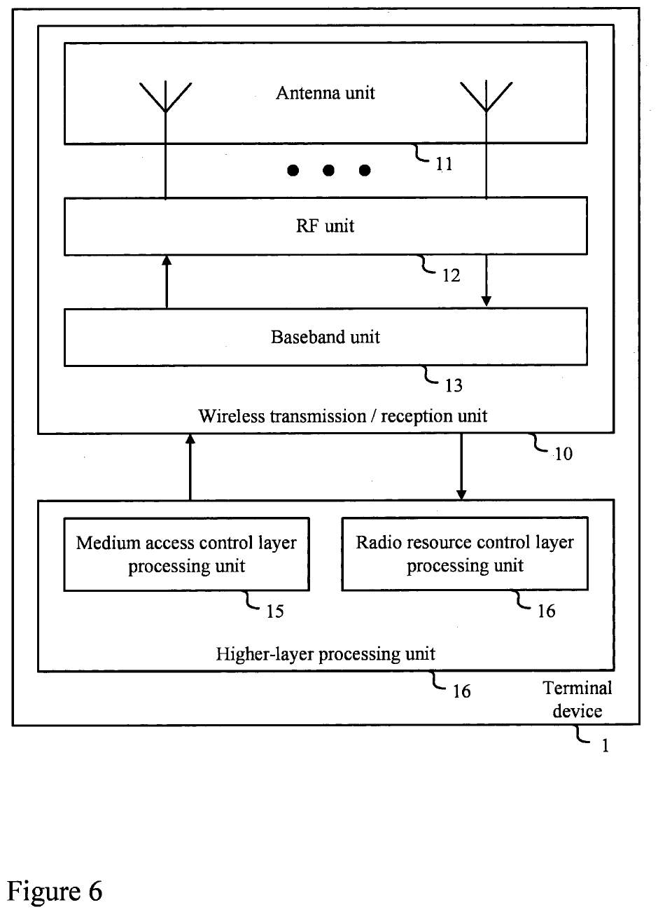

FIG. 6 is a schematic block diagram showing a configuration example of the terminal device 1. As shown in FIG. 6, the terminal device 1 includes at least a part or all of the wireless transmission/reception unit (physical layer processing unit) 10 and the higher-layer processing unit 14. The wireless transmission/reception unit 10 includes at least a part or all of the antenna unit 11, the RF unit 12, and the baseband unit 13. The higher-layer processing unit 14 includes at least a part or all of the medium access control layer processing unit 15 and the radio resource control layer processing unit 16.

The wireless transmission/reception unit 10 includes at least a part of or all of a wireless transmission unit 10a and a wireless reception unit 10b. The configuration of the baseband unit 13 included in the wireless transmission unit 10a and the configuration of the baseband unit 13 included in the wireless reception unit 10b may be the same or different. The configuration of the RF unit 12 included in the wireless transmission unit 10a and the RF unit 12 included in the wireless reception unit 10b may be the same or different. The configuration of the antenna unit 11 included in the wireless transmission unit 10a and the configuration of the antenna unit 11 included in the wireless reception unit 10b may be the same or different.

The higher-layer processing unit 14 provides uplink or sidelink data (a transport block) to the wireless transmission/reception unit 10 (or the wireless transmission unit 10a). The higher-layer processing unit 14 performs processing of a MAC layer, a packet data integration protocol layer, a radio link control layer, and/or an RRC layer. The higher-layer processing unit 14 may also performs processing of a MAC layer, a packet data integration protocol layer, a radio link control layer, and/or an RRC layer for PC5.

The medium access control layer processing unit 15 included in the higher-layer processing unit 14 performs processing of the MAC layer.

The radio resource control layer processing unit 16 included in the higher-layer processing unit 14 performs the process of the RRC layer and/or the PC5 RRC (PC5-RRC) process. The radio resource control layer processing unit 16 manages various configuration information/parameters (RRC parameters and/or PC5 RRC (PC5-RRC) parameters) of the terminal device 1. The radio resource control layer processing unit 16 configures RRC parameters based on the RRC message received from the base station device 3 and/or PC5 RRC parameters based on the PC5 RRC (PC5-RRC) message received from another terminal device.

The wireless transmission/reception unit 10 (or the wireless transmission unit 10a) performs processing such as encoding and modulation. The wireless transmission/reception unit 10 (or the wireless transmission unit 10a) generates a physical signal by encoding and modulating the uplink data and/or sidelink data. The wireless transmission/reception unit 10 (or the wireless transmission unit 10a) converts OFDM symbols in the physical signal to a baseband signal by conversion to a time-continuous signal. The wireless transmission/reception unit 10 (or the wireless transmission unit 10a) transmits the baseband signal (or the physical signal) to the base station device 3 or to another terminal device via radio frequency. The wireless transmission/reception unit 10 (or the wireless transmission unit 10a) may arrange the baseband signal (or the physical signal) on a BWP (active uplink BWP) and transmit the baseband signal (or the physical signal) to the base station device 3.

The wireless transmission/reception unit 10 (or the wireless reception unit 10b) performs processing such as demodulation and decoding. The wireless transmission/reception unit 10 (or the wireless reception unit 10b) may receive a physical signal in a BWP (active downlink BWP) of a serving cell and/or in a Sidelink BWP. The wireless transmission/reception unit 10 (or the wireless reception unit 10b) separates, demodulates and decodes the received physical signal, and provides the decoded information to the higher-layer processing unit 14. The wireless transmission/reception unit 10 (or the wireless reception unit 10b) may perform the channel access procedure prior to the transmission of the physical signal.

The RF unit 12 demodulates the physical signal received via the antenna unit 11 into a baseband signal (down convert), and/or removes extra frequency components. The RF unit 12 provides the processed analog signal to the baseband unit 13.

The baseband unit 13 converts an analog signal (signals on radio frequency) input from the RF unit 12 into a digital signal (a baseband signal). The baseband unit 13 separates a portion which corresponds to CP from the digital signal, performs fast Fourier transformation on the digital signal from which the CP has been removed, and provides the physical signal in the frequency domain.

The baseband unit 13 performs inverse fast Fourier transformation on uplink data to generate an OFDM symbol, adds a CP to the generated OFDM symbol, generates a digital signal (baseband signal), and convert the digital signal into an analog signal. The baseband unit 13 provides the analog signal to the RF unit 12.

The RF unit 12 removes extra frequency components from the analog signal (signals on radio frequency) input from the baseband unit 13, up-converts the analog signal to a radio frequency, and transmits it via the antenna unit 11 The RF unit 12 may have a function of controlling transmission power. The RF unit 12 is also referred to as a transmission power control unit.

Hereinafter, physical signals (signals) will be described.

Physical signal is a generic term for downlink physical channels, downlink physical signals, uplink physical channels, uplink physical signals, sidelink physical channels, and sidelink physical signals. The physical channel is a generic term for downlink physical channels, uplink physical channels and sidelink physical channels.

An uplink physical channel may correspond to a set of resource elements that carry information originating from the higher-layer and/or uplink control information. The uplink physical channel may be a physical channel used in an uplink component carrier. The uplink physical channel may be transmitted by the terminal device 1. The uplink physical channel may be received by the base station device 3. In the wireless communication system according to one aspect of the present embodiment, at least part or all of PUCCH (Physical Uplink Control CHannel), PUSCH (Physical Uplink Shared CHannel), and PRACH (Physical Random Access CHannel) may be used.

A PUCCH may be used to transmit uplink control information (UCI). The PUCCH may be sent to deliver (transmission, convey) uplink control information. The uplink control information may be mapped to (or arranged in) the PUCCH. The terminal device 1 may transmit PUCCH in which uplink control information is arranged. The base station device 3 may receive the PUCCH in which the uplink control information is arranged.

Uplink control information (uplink control information bit, uplink control information sequence, uplink control information type) includes at least part or all of channel state information (CSI), scheduling request (SR), and HARQ-ACK (Hybrid Automatic Repeat request ACKnowledgement).

Channel state information is conveyed by using channel state information bits or a channel state information sequence. Scheduling request is also referred to as a scheduling request bit or a scheduling request sequence. HARQ-ACK information is also referred to as a HARQ-ACK information bit or a HARQ-ACK information sequence.

HARQ-ACK information may include HARQ-ACK status which corresponds to a transport block (TB: Transport block, MAC PDU: Medium Access Control Protocol Data Unit, DL-SCH: Downlink-Shared Channel, UL-SCH: Uplink-Shared Channel, PDSCH: Physical Downlink Shared CHannel, PUSCH: Physical Uplink Shared CHannel). The HARQ-ACK status may indicate ACK (acknowledgement) or NACK (negative-acknowledgement) corresponding to the transport block. The ACK may indicate that the transport block has been successfully decoded. The NACK may indicate that the transport block has not been successfully decoded. The HARQ-ACK information may include a HARQ-ACK codebook that includes one or more HARQ-ACK status (or HARQ-ACK bits).

For example, the correspondence between the HARQ-ACK information and the transport block may mean that the HARQ-ACK information and the PDSCH used for transmission of the transport block correspond.

HARQ-ACK status may indicate ACK or NACK which correspond to one CBG (Code Block Group) included in the transport block.

The scheduling request may at least be used to request PUSCH (or UL-SCH) resources for new transmission. The scheduling request may be used to indicate either a positive SR or a negative SR. The fact that the scheduling request indicates a positive SR is also referred to as “a positive SR is sent”. The positive SR may indicate that the PUSCH (or UL-SCH) resource for initial transmission is requested by the terminal device 1. A positive SR may indicate that a higher-layer is to trigger a scheduling request. The positive SR may be sent when the higher-layer instructs to send a scheduling request. The fact that the scheduling request bit indicates a negative SR is also referred to as “a negative SR is sent”. A negative SR may indicate that the PUSCH (or UL-SCH) resource for initial transmission is not requested by the terminal device 1. A negative SR may indicate that the higher-layer does not trigger a scheduling request. A negative SR may be sent if the higher-layer is not instructed to send a scheduling request.

The channel state information may include at least part or all of a channel quality indicator (CQI), a precoder matrix indicator (PMI), and a rank indicator (RI). CQI is an indicator related to channel quality (e.g., propagation quality) or physical channel quality, and PMI is an indicator related to a precoder. RI is an indicator related to transmission rank (or the number of transmission layers).

Channel state information may be provided at least based on receiving one or more physical signals (e.g., one or more CSI-RSs) used at least for channel measurement. The channel state information may be selected by the terminal device 1 at least based on receiving one or more physical signals used for channel measurement. Channel measurements may include interference measurements.

A PUCCH may correspond to a PUCCH format. A PUCCH may be a set of resource elements used to convey a PUCCH format. A PUCCH may include a PUCCH format. A PUCCH format may include UCI.

A PUSCH may be used to transmit uplink data (a transport block) and/or uplink control information. A PUSCH may be used to transmit uplink data (a transport block) corresponding to a UL-SCH and/or uplink control information. A PUSCH may be used to convey uplink data (a transport block) and/or uplink control information. A PUSCH may be used to convey uplink data (a transport block) corresponding to a UL-SCH and/or uplink control information. Uplink data (a transport block) may be arranged in a PUSCH. Uplink data (a transport block) corresponding to UL-SCH may be arranged in a PUSCH. Uplink control information may be arranged to a PUSCH. The terminal device 1 may transmit a PUSCH in which uplink data (a transport block) and/or uplink control information is arranged. The base station device 3 may receive a PUSCH in which uplink data (a transport block) and/or uplink control information is arranged.

A PRACH may be used to transmit a random-access preamble. The PRACH may be used to convey a random-access preamble. The sequence x_{u, v}(n) of the PRACH is defined by x_{u,v}(n)=xᵤ (mod (n+Cᵥ, L_{RA})). The xᵤ may be a ZC sequence (Zadoff-Chu sequence). The xᵤ may be defined by xᵤ=exp (−jpui (i+1)/L_{RA}). The j is an imaginary unit. The p is the circle ratio. The Cᵥ corresponds to cyclic shift of the PRACH. L_{RA} corresponds to the length of the PRACH. The L_{RA} may be 839 or 139 or another value. The i is an integer in the range of 0 to L_{RA}−1. The u is a sequence index for the PRACH. The terminal device 1 may transmit the PRACH. The base station device 3 may receive the PRACH.

For a given PRACH opportunity, 64 random-access preambles are defined. The random-access preamble is specified (determined, given) at least based on the cyclic shift Cᵥ of the PRACH and the sequence index u for the PRACH.

An uplink physical signal may correspond to a set of resource elements. The uplink physical signal may not carry information generated in the higher-layer. The uplink physical signal may be a physical signal used in the uplink component carrier. The terminal device 1 may transmit an uplink physical signal. The base station device 3 may receive the uplink physical signal. In the radio communication system according to one aspect of the present embodiment, at least a part or all of UL DMRS (UpLink Demodulation Reference Signal), SRS (Sounding Reference Signal), UL PTRS (UpLink Phase Tracking Reference Signal) may be used.

UL DMRS is a generic name of a DMRS for a PUSCH and a DMRS for a PUCCH.

A set of antenna ports of a DMRS for a PUSCH (a DMRS associated with a PUSCH, a DMRS included in a PUSCH, a DMRS which corresponds to a PUSCH) may be given based on a set of antenna ports for the PUSCH. That is, the set of DMRS antenna ports for the PUSCH may be the same as the set of antenna ports for the PUSCH.

Transmission of a PUSCH and transmission of a DMRS for the PUSCH may be indicated (or scheduled) by one DCI format. The PUSCH and the DMRS for the PUSCH may be collectively referred to as a PUSCH. Transmission of the PUSCH may be transmission of the PUSCH and the DMRS for the PUSCH.

A PUSCH may be estimated from a DMRS for the PUSCH. That is, propagation path of the PUSCH may be estimated from the DMRS for the PUSCH.

A set of antenna ports of a DMRS for a PUCCH (a DMRS associated with a PUCCH, a DMRS included in a PUCCH, a DMRS which corresponds to a PUCCH) may be identical to a set of antenna ports for the PUCCH.

Transmission of a PUCCH and transmission of a DMRS for the PUCCH may be indicated (or triggered) by one DCI format. The arrangement of the PUCCH in resource elements (resource element mapping) and/or the arrangement of the DMRS in resource elements for the PUCCH may be provided at least by one PUCCH format. The PUCCH and the DMRS for the PUCCH may be collectively referred to as PUCCH. Transmission of the PUCCH may be transmission of the PUCCH and the DMRS for the PUCCH.

A PUCCH may be estimated from a DMRS for the PUCCH. That is, propagation path of the PUCCH may be estimated from the DMRS for the PUCCH.

A downlink physical channel may correspond to a set of resource elements that carry information originating from the higher-layer and/or downlink control information. The downlink physical channel may be a physical channel used in the downlink component carrier. The base station device 3 may transmit the downlink physical channel. The terminal device 1 may receive the downlink physical channel. In the wireless communication system according to one aspect of the present embodiment, at least a part or all of PBCH (Physical Broadcast Channel), PDCCH (Physical Downlink Control Channel), and PDSCH (Physical Downlink Shared Channel) may be used.

The PBCH may be used to transmit a MIB (Master Information Block) and/or physical layer control information. The physical layer control information is a kind of downlink control information. The PBCH may be sent to deliver the MIB and/or the physical layer control information. A BCH may be mapped (or corresponding) to the PBCH. The terminal device 1 may receive the PBCH. The base station device 3 may transmit the PBCH. The physical layer control information is also referred to as a PBCH payload and a PBCH payload related to timing. The MIB may include one or more higher-layer parameters.

Physical layer control information includes 8 bits. The physical layer control information may include at least part or all of 0A to 0D. The 0A is radio frame information. The 0B is half radio frame information (half system frame information). The 0C is SS/PBCH block index information. The 0D is subcarrier offset information.

The radio frame information is used to indicate a radio frame in which the PBCH is transmitted (a radio frame including a slot in which the PBCH is transmitted). The radio frame information is represented by 4 bits. The radio frame information may be represented by 4 bits of a radio frame indicator. The radio frame indicator may include 10 bits. For example, the radio frame indicator may at least be used to identify a radio frame from index 0 to index 1023.

The half radio frame information is used to indicate whether the PBCH is transmitted in first five subframes or in second five subframes among radio frames in which the PBCH is transmitted. Here, the half radio frame may be configured to include five subframes. The half radio frame may be configured by five subframes of the first half of ten subframes included in the radio frame. The half radio frame may be configured by five subframes in the second half of ten subframes included in the radio frame.

The SS/PBCH block index information is used to indicate an SS/PBCH block index. The SS/PBCH block index information may be represented by 3 bits. The SS/PBCH block index information may consist of 3 bits of an SS/PBCH block index indicator. The SS/PBCH block index indicator may include 6 bits. The SS/PBCH block index indicator may at least be used to identify an SS/PBCH block from index 0 to index 63 (or from index 0 to index 3, from index 0 to index 7, from index 0 to index 9, from index 0 to index 19, etc.).

The subcarrier offset information is used to indicate subcarrier offset. The subcarrier offset information may be used to indicate the difference between the first subcarrier in which the PBCH is arranged and the first subcarrier in which the control resource set with index 0 is arranged.

A PDCCH may be used to transmit downlink control information (DCI). A PDCCH may be transmitted to deliver downlink control information. Downlink control information may be mapped to a PDCCH. The terminal device 1 may receive a PDCCH in which downlink control information is arranged. The base station device 3 may transmit the PDCCH in which the downlink control information is arranged.

Downlink control information may correspond to a DCI format. Downlink control information may be included in a DCI format. Downlink control information may be arranged in each field of a DCI format.

DCI format is a generic name for DCI format 0_0, DCI format 0_1, DCI format 1_0, and DCI format 1_1. Uplink DCI format is a generic name of the DCI format 0_0 and the DCI format 0_1. Downlink DCI format is a generic name of the DCI format 1_0 and the DCI format 1_1.

A PDSCH may be used to transmit one or more transport blocks. A PDSCH may be used to transmit one or more transport blocks which corresponds to a DL-SCH. A PDSCH may be used to convey one or more transport blocks. A PDSCH may be used to convey one or more transport blocks which corresponds to a DL-SCH. One or more transport blocks may be arranged in a PDSCH. One or more transport blocks which corresponds to a DL-SCH may be arranged in a PDSCH. The base station device 3 may transmit a PDSCH. The terminal device 1 may receive the PDSCH.

Downlink physical signals may correspond to a set of resource elements. The downlink physical signals may not carry the information generated in the higher-layer. The downlink physical signals may be physical signals used in the downlink component carrier. A downlink physical signal may be transmitted by the base station device 3. The downlink physical signal may be transmitted by the terminal device 1. In the wireless communication system according to one aspect of the present embodiment, at least a part or all of an SS (Synchronization signal), DL DMRS (DownLink DeModulation Reference Signal), CSI-RS (Channel State Information-Reference Signal), and DL PTRS (DownLink Phase Tracking Reference Signal) may be used.

The synchronization signal may be used at least for the terminal device 1 to synchronize in the frequency domain and/or time domain for downlink. The synchronization signal is a generic name of PSS (Primary Synchronization Signal) and SSS (Secondary Synchronization Signal).

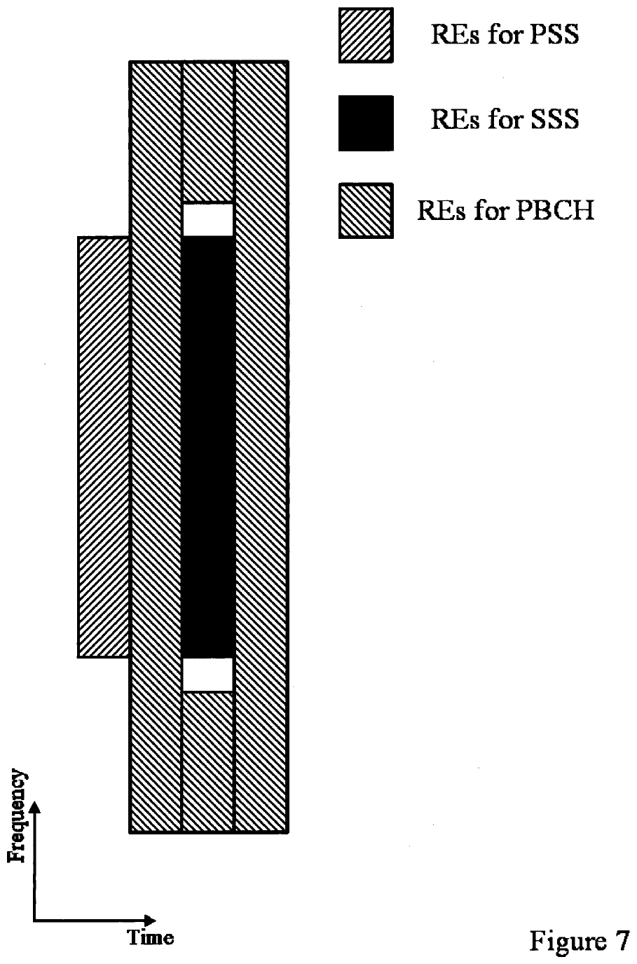

FIG. 7 is a diagram showing a configuration example of an SS/PBCH block. In FIG. 7, the horizontal axis indicates time domain (OFDM symbol index 1_{symb}), and the vertical axis indicates frequency domain. The shaded blocks indicate a set of resource elements for a PSS. The blocks of grid lines indicate a set of resource elements for an SSS. Also, the blocks in the horizontal line indicate a set of resource elements for a PBCH and a set of resource elements for a DMRS for the PBCH (DMRS related to the PBCH, DMRS included in the PBCH, DMRS which corresponds to the PBCH).

As shown in FIG. 7, the SS/PBCH block includes a PSS, an SSS, and a PBCH. The SS/PBCH block includes 4 consecutive OFDM symbols. The SS/PBCH block includes 240 subcarriers. The PSS is allocated to the 57th to 183rd subcarriers in the first OFDM symbol. The SSS is allocated to the 57th to 183rd subcarriers in the third OFDM symbol. The first to 56th subcarriers of the first OFDM symbol may be set to zero. The 184th to 240th subcarriers of the first OFDM symbol may be set to zero. The 49th to 56th subcarriers of the third OFDM symbol may be set to zero. The 184th to 192nd subcarriers of the third OFDM symbol may be set to zero. In the first to 240th subcarriers of the second OFDM symbol, the PBCH is allocated to subcarriers in which the DMRS for the PBCH is not allocated. In the first to 48th subcarriers of the third OFDM symbol, the PBCH is allocated to subcarriers in which the DMRS for the PBCH is not allocated. In the 193rd to 240th subcarriers of the third OFDM symbol, the PBCH is allocated to subcarriers in which the DMRS for the PBCH is not allocated. In the first to 240th subcarriers of the 4th OFDM symbol, the PBCH is allocated to subcarriers in which the DMRS for the PBCH is not allocated.

The antenna ports of a PSS, an SSS, a PBCH, and a DMRS for the PBCH in an SS/PBCH block may be identical.

A PBCH may be estimated from a DMRS for the PBCH. For the DM-RS for the PBCH, the channel over which a symbol for the PBCH on an antenna port is conveyed can be inferred from the channel over which another symbol for the DM-RS on the antenna port is conveyed only if the two symbols are within a SS/PBCH block transmitted within the same slot, and with the same SS/PBCH block index.

DL DMRS is a generic name of DMRS for a PBCH, DMRS for a PDSCH, and DMRS for a PDCCH.

A set of antenna ports for a DMRS for a PDSCH (a DMRS associated with a PDSCH, a DMRS included in a PDSCH, a DMRS which corresponds to a PDSCH) may be given based on the set of antenna ports for the PDSCH. The set of antenna ports for the DMRS for the PDSCH may be the same as the set of antenna ports for the PDSCH.

Transmission of a PDSCH and transmission of a DMRS for the PDSCH may be indicated (or scheduled) by one DCI format. The PDSCH and the DMRS for the PDSCH may be collectively referred to as PDSCH. Transmitting a PDSCH may be transmitting a PDSCH and a DMRS for the PDSCH.

A PDSCH may be estimated from a DMRS for the PDSCH. For a DM-RS associated with a PDSCH, the channel over which a symbol for the PDSCH on one antenna port is conveyed can be inferred from the channel over which another symbol for the DM-RS on the antenna port is conveyed only if the two symbols are within the same resource as the scheduled PDSCH, in the same slot, and in the same PRG (Precoding Resource Group).

Antenna ports for a DMRS for a PDCCH (a DMRS associated with a PDCCH, a DMRS included in a PDCCH, a DMRS which corresponds to a PDCCH) may be the same as an antenna port for the PDCCH.

A PDCCH may be estimated from a DMRS for the PDCCH. For a DM-RS associated with a PDCCH, the channel over which a symbol for the PDCCH on one antenna port is conveyed can be inferred from the channel over which another symbol for the DM-RS on the same antenna port is conveyed only if the two symbols are within resources for which the UE may assume the same precoding being used (i.e. within resources in a REG bundle).

ABCH (Broadcast CHannel), a UL-SCH (Uplink-Shared CHannel) and a DL-SCH (Downlink-Shared CHannel) are transport channels. A channel used in the MAC layer is called a transport channel. A unit of transport channel used in the MAC layer is also called transport block (TB) or MAC PDU (Protocol Data Unit). In the MAC layer, control of HARQ (Hybrid Automatic Repeat request) is performed for each transport block. The transport block is a unit of data delivered by the MAC layer to the physical layer. In the physical layer, transport blocks are mapped to codewords and modulation processing is performed for each codeword.

One UL-SCH and one DL-SCH may be provided for each serving cell. BCH may be given to PCell. BCH may not be given to PSCell and SCell.

ABCCH (Broadcast Control CHannel), a CCCH (Common Control CHannel), and a DCCH (Dedicated Control CHannel) are logical channels. The BCCH is a channel of the RRC layer used to deliver MIB or system information. The CCCH may be used to transmit a common RRC message in a plurality of terminal devices 1. The CCCH may be used for the terminal device 1 which is not connected by RRC. The DCCH may be used at least to transmit a dedicated RRC message to the terminal device 1. The DCCH may be used for the terminal device 1 that is in RRC-connected mode.

The RRC message includes one or more RRC parameters (information elements, higher layer parameters). For example, the RRC message may include a MIB. For example, the RRC message may include system information (SIB: System Information Block, MIB). SIB is a generic name for various type of SIBs (e.g., SIB1, SIB2). For example, the RRC message may include a message which corresponds to a CCCH. For example, the RRC message may include a message which corresponds to a DCCH. RRC message is a general term for common RRC message and dedicated RRC message.

The BCCH in the logical channel may be mapped to the BCH or the DL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to a PUSCH in the physical channel. The DL-SCH in the transport channel may be mapped to a PDSCH in the physical channel. The BCH in the transport channel may be mapped to a PBCH in the physical channel.

A higher-layer parameter is a parameter included in an RRC message or a MAC CE (Medium Access Control Control Element). The higher-layer parameter is a generic name of information included in a MIB, system information, a message which corresponds to CCCH, a message which corresponds to DCCH, and a MAC CE. A higher-layer parameter may be referred to as an RRC parameter or an RRC configuration if the higher-layer parameter is the parameter included in the RRC message.

A higher-layer parameter may be a cell-specific parameter or a UE-specific parameter. A cell-specific parameter is a parameter including a common configuration in a cell. A UE-specific parameter is a parameter including a configuration that may be configured differently for each UE.

The base station device may indicate change of cell-specific parameters by reconfiguration with random-access. The UE may change cell-specific parameters before triggering random-access. The base station device may indicate change of UE-specific parameters by reconfiguration with or without random-access. The UE may change UE-specific parameters before or after random-access.

The procedure performed by the terminal device 1 includes at least a part or all of the following 5A to 5C. The 5A is cell search. The 5B is random-access. The 5C is data communication.

The cell search is a procedure used by the terminal device 1 to synchronize with a cell in the time domain and/or the frequency domain and to detect a physical cell identity. The terminal device 1 may detect the physical cell ID by performing synchronization of time domain and/or frequency domain with a cell by the cell search.

A sequence of a PSS is given based at least on a physical cell ID. A sequence of an SSS is given based at least on the physical cell ID.

An SS/PBCH block candidate indicates a resource for which transmission of the SS/PBCH block may exist. An SS/PBCH block may be transmitted at a resource indicated as the SS/PBCH block candidate. The base station device 3 may transmit an SS/PBCH block at an SS/PBCH block candidate. The terminal device 1 may receive (detect) the SS/PBCH block at the SS/PBCH block candidate.

A set of SS/PBCH block candidates in a half radio frame is also referred to as an SS-burst-set. The SS-burst-set is also referred to as a transmission window, a SS transmission window, or a DRS transmission window (Discovery Reference Signal transmission window). The SS-burst-set is a generic name that includes at least a first SS-burst-set and a second SS-burst-set.

The base station device 3 transmits SS/PBCH blocks of one or more indexes at a predetermined cycle. The terminal device 1 may detect an SS/PBCH block of at least one of the SS/PBCH blocks of the one or more indexes. The terminal device 1 may attempt to decode the PBCH included in the SS/PBCH block.

The random-access is a procedure including at least a part or all of message 1, message 2, message 3, and message 4.

The message 1 is a procedure in which the terminal device 1 transmits a PRACH. The terminal device 1 transmits the PRACH in one PRACH occasion selected from among one or more PRACH occasions based on at least the index of the SS/PBCH block candidate detected based on the cell search.

The message 2 is a procedure in which the terminal device 1 attempts to detect a DCI format 1_0 with CRC (Cyclic Redundancy Check) scrambled by an RA-RNTI (Random Access-Radio Network Temporary Identifier). The terminal device 1 may attempt to detect the DCI format 1_0 in a search-space-set.

The message 3 (Msg 3) is a procedure for transmitting a PUSCH scheduled by a random-access response grant included in the DCI format 1_0 detected in the message 2 procedure. The random-access response grant is indicated by the MAC CE included in the PDSCH scheduled by the DCI format 1_0.

The PUSCH scheduled based on the random-access response grant is either a message 3 PUSCH or a PUSCH. The message 3 PUSCH contains a contention resolution identifier MAC CE. The contention resolution ID MAC CE includes a contention resolution ID.

Retransmission of the message 3 PUSCH is scheduled by DCI format 0_0 with CRC scrambled by a TC-RNTI (Temporary Cell-Radio Network Temporary Identifier).

The message 4 is a procedure that attempts to detect a DCI format 1_0 with CRC scrambled by either a C-RNTI (Cell-Radio Network Temporary Identifier) or a TC-RNTI. The terminal device 1 receives a PDSCH scheduled based on the DCI format 1_0. The PDSCH may include a collision resolution ID.

Data communication is a generic term for downlink communication and uplink communication.

In data communication, the terminal device 1 attempts to detect a PDCCH (attempts to monitor a PDCCH, monitors a PDCCH). in a resource identified at least based on one or all of a control resource set and a search-space-set. It's also called as “the terminal device 1 attempts to detect a PDCCH in a control resource set”, “the terminal device 1 attempts to detect a PDCCH in a search-space-set”, “the terminal device 1 attempts to detect a PDCCH candidate in a control resource set”, “the terminal device 1 attempts to detect a PDCCH candidate in a search-space-set”, “the terminal device 1 attempts to detect a DCI format in a control resource set”, or “the terminal device 1 attempts to detect a DCI format in a search-space-set”. Monitoring a PDCCH may be equivalent as monitoring a DCI format in the PDCCH.

The control resource set is a set of resources configured by the number of resource blocks and a predetermined number of OFDM symbols in a slot.

The set of resources for the control resource set may be indicated by higher-layer parameters. The number of OFDM symbols included in the control resource set may be indicated by higher-layer parameters.

A PDCCH may be also called as a PDCCH candidate.

A search-space-set is defined as a set of PDCCH candidates. A search-space-set may be a Common Search Space (CSS) set or a UE-specific Search Space (USS) set.

The CSS set is a generic name of a type-0 PDCCH common search-space-set, a type-0a PDCCH common search-space-set, a type-1 PDCCH common search-space-set, a type-2 PDCCH common search-space-set, and a type-3 PDCCH common search-space-set. The USS set may be also called as UE-specific PDCCH search-space-set.

The type-0 PDCCH common search-space-set may be used as a common search-space-set with index 0. The type-0 PDCCH common search-space-set may be an common search-space-set with index 0.

A search-space-set is associated with (included in, corresponding to) a control resource set. The index of the control resource set associated with the search-space-set may be indicated by higher-layer parameters.

For a search-space-set, a part or all of 6A to 6C may be indicated at least by higher-layer parameters. The 6A is PDCCH monitoring period. The 6B is PDCCH monitoring pattern within a slot. The 6C is PDCCH monitoring offset.

A monitoring occasion of a search-space-set may correspond to one or more OFDM symbols in which the first OFDM symbol of the control resource set associated with the search-space-set is allocated. A monitoring occasion of a search-space-set may correspond to resources identified by the first OFDM symbol of the control resource set associated with the search-space-set. A monitoring occasion of a search-space-set is given based at least on a part or all of PDCCH monitoring periodicity, PDCCH monitoring pattern within a slot, and PDCCH monitoring offset.

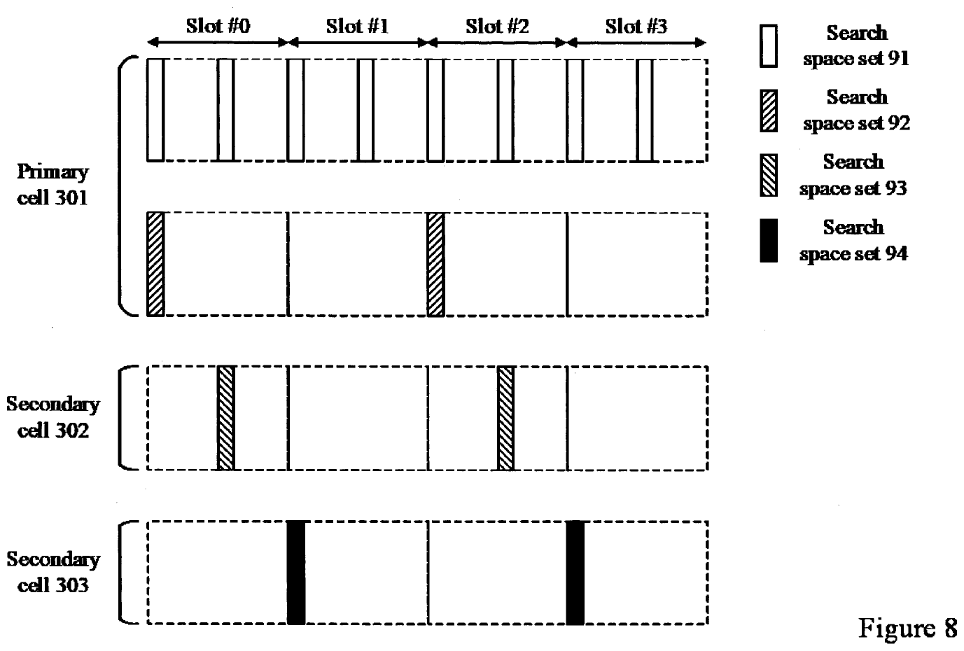

FIG. 8 is a diagram showing an example of the monitoring occasion of the search-space-set. In FIG. 8, the search-space-set 91 and the search-space-set 92 are sets in the primary cell 301, the search-space-set 93 is a set in the secondary cell 302, and the search-space-set 94 is a set in the secondary cell 303.

In FIG. 8, the block indicated by the grid line indicates the search-space-set 91, the block indicated by the upper right diagonal line indicates the search-space-set 92, the block indicated by the upper left diagonal line indicates the search-space-set 93, and the block indicated by the horizontal line indicates the search-space-set 94.

In FIG. 8, the PDCCH monitoring periodicity for the search-space-set 91 is set to 1 slot, the PDCCH monitoring offset for the search-space-set 91 is set to 0 slot, and the PDCCH monitoring pattern for the search-space-set 91 is b[1, 0, 0, 0, 0, 0, 0, 1, 0, 0, 0, 0, 0, 0]. That is, the monitoring occasion of the search-space-set 91 corresponds to the first OFDM symbol (OFDM symbol #0) and the eighth OFDM symbol (OFDM symbol #7) in each of the slots.

In FIG. 8, the PDCCH monitoring periodicity for the search-space-set 92 is set to 2 slots, the PDCCH monitoring offset for the search-space-set 92 is set to 0 slots, and the PDCCH monitoring pattern for the search-space-set 92 is [1, 0, 0, 0, 0, 0, 0, 0, 0, 0, 0, 0, 0, 0]. That is, the monitoring occasion of the search-space-set 92 corresponds to the leading OFDM symbol (OFDM symbol #0) in each of the even slots.

In FIG. 8, the PDCCH monitoring periodicity for the search-space-set 93 is set to 2 slots, the PDCCH monitoring offset for the search-space-set 93 is set to 0 slots, and the PDCCH monitoring pattern for the search-space-set 93 is [0, 0, 0, 0, 0, 0, 0, 1, 0, 0, 0, 0, 0, 0]. That is, the monitoring occasion of the search-space-set 93 corresponds to the eighth OFDM symbol (OFDM symbol #8) in each of the even slots.

In FIG. 8, the PDCCH monitoring periodicity for the search-space-set 94 is set to 2 slots, the PDCCH monitoring offset for the search-space-set 94 is set to 1 slot, and the PDCCH monitoring pattern for the search-space-set 94 is [1, 0, 0, 0, 0, 0, 0, 0, 0, 0, 0, 0, 0, 0]. That is, the monitoring occasion of the search-space-set 94 corresponds to the leading OFDM symbol (OFDM symbol #0) in each of the odd slots.

The type-0 PDCCH common search-space-set may be at least used for a DCI format with a cyclic redundancy check (CRC) sequence scrambled by an SI-RNTI (System Information-Radio Network Temporary Identifier).

The type-0a PDCCH common search-space-set may be used at least for a DCI format with a cyclic redundancy check sequence scrambled by an SI-RNTI.

The type-1 PDCCH common search-space-set may be used at least for a DCI format with a CRC sequence scrambled by an RA-RNTI (Random Access-Radio Network Temporary Identifier) or a CRC sequence scrambled by a TC-RNTI (Temporary Cell-Radio Network Temporary Identifier).

The type-2 PDCCH common search-space-set may be used for a DCI format with a CRC sequence scrambled by P-RNTI (Paging-Radio Network Temporary Identifier).

The type-3 PDCCH common search-space-set may be used for a DCI format with a CRC sequence scrambled by a C-RNTI (Cell-Radio Network Temporary Identifier).

The UE-specific search-space-set may be used at least for a DCI format with a CRC sequence scrambled by a C-RNTI.

In downlink communication, the terminal device 1 may detect a downlink DCI format. The detected downlink DCI format is at least used for resource assignment for a PDSCH. The detected downlink DCI format is also referred to as downlink assignment. The terminal device 1 attempts to receive the PDSCH. Based on a PUCCH resource indicated based on the detected downlink DCI format, an HARQ-ACK corresponding to the PDSCH (HARQ-ACK corresponding to a transport block included in the PDSCH) may be reported to the base station device 3.

In uplink communication, the terminal device 1 may detect an uplink DCI format. The detected uplink DCI format is at least used for resource assignment for a PUSCH. The detected uplink DCI format is also referred to as uplink grant. The terminal device 1 transmits the PUSCH.

PUSCH transmission(s) can be dynamically scheduled by an UL grant in a DCI, or the transmission can correspond to a configured grant Type 1 or Type 2. The configured grant Type 1 PUSCH transmission is semi-statically configured to operate upon the reception of higher layer parameter of configuredGrantConfig including rrc-ConfiguredUplinkGrant without the detection of an UL grant in a DCI. The configured grant Type 2 PUSCH transmission is semi-persistently scheduled by an UL grant in a valid activation DCI according to those procedure(s) after the reception of higher layer parameter configuredGrantConfig not including rrc-ConfiguredUplinkGrant. If configuredGrantConfigToAddModList is configured, more than one configured grant configuration of configured grant Type 1 and/or configured grant Type 2 may be active at the same time on an active BWP of a serving cell.

Sidelink (SL) communication is described hereafter.

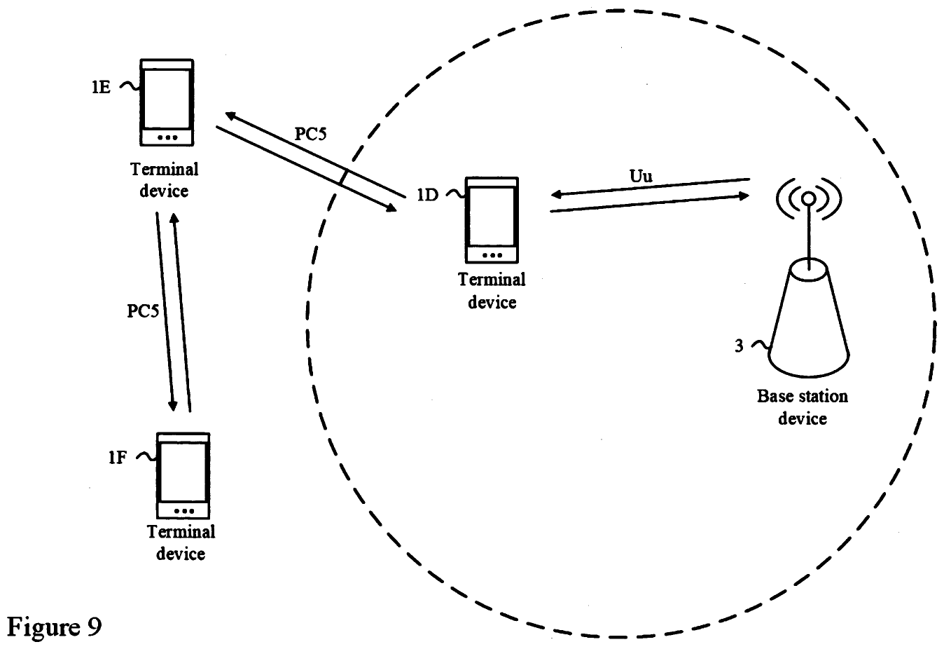

FIG. 9 is another conceptual diagram of a wireless communication system. In FIG. 9, the wireless communication system using sidelink may include terminal device 1D to 1F and a base station device 3 (BS #3: Base station #3). Hereinafter, the terminal devices 1D to 1F are also referred to as a terminal device 1 (UE #1: User Equipment #1). The reference point between terminal devices is referred to as PC5 reference point (also referred to as PC5). The reference point between terminal device and the base station is referred to as Uu reference point (also referred to as Uu).

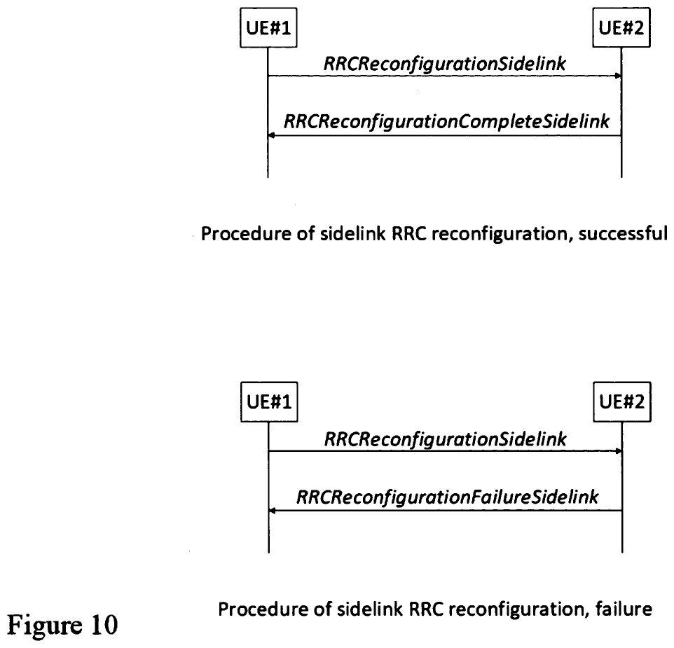

The sidelink communication can be done over the PC5. FIG. 10 shows procedures of sidelink RRC reconfiguration. The procedure may include a step that UE #1 sends a PC5 RRC message (i.e. RRCReconfigurationSidelink) to the peer UE (i.e. UE #2). The procedure may also include a step that UE #2 sends a response PC5 RRC message (i.e. RRCReconfigurationCompleteSidelink when completed or RRCReconfigurationFairureSidelink when failed) to UE #1. The purpose of this procedures may be to modify a PC5-RRC connection, e.g. to establish/modify/release sidelink DRBs associated with the peer UE, to (re-)configure the peer UE to perform NR sidelink measurement and reporting, to (re-)configure sidelink CSI reference signal resources and CSI reporting latency bound, to (re-)configure the peer UE to perform measurement and reporting for sidelink based positioning, and/or to (re-)configure reference signal resources for sidelink based positioning. In RRC_CONNECTED, the UE may apply the NR sidelink communications parameters provided in RRCReconfiguration (dedicated RRC message) that is provided by a base station 3, if any. In RRC_IDLE or RRC_INACTIVE, the UE may apply the NR sidelink communications parameters provided in system information that is provided by a base station 3, if any. For other cases, UEs may apply the NR sidelink communications parameters provided in SidelinkPreconfigNR, if any.

Sidelink supports UE-to-UE direct communication using two sidelink resource allocation modes. In mode 1, the sidelink resource allocation may be provided by the network. In mode 2, UE may decide the SL transmission resources in the resource pool(s). For the sidelink communication over PC5, the operator may pre-configure the UEs with required provisioning parameters for the sidelink communication, without the need for the UEs to connect to the 5G Core network to get initial configuration. The memory storing the pre-configured parameters (e.g. parameters in SidelinkPreconfigNR) may be prospectively incorporated in the UE or in UICC (Universal Integrated Circuit Card) or both of them. In mode 2, the pre-configured parameters may be used.

The base station device 3 may be configured to include one or more transmission devices (or transmission points, transmission devices, reception devices, transmission points, reception points). When the base station device 3 is configured by a plurality of transmission devices, each of the plurality of transmission devices may be arranged at a different position. The base station device 3 may send or broadcast SIB (system information block) containing sidelink configuration information for sidelink communication.

The terminal device 1D may detect at least one cell on the frequency which the terminal device 1D is configured to perform NR sidelink communication on fulfilling the criterion (e.g. cell selection or cell reselection criterion). In this case, the terminal device 1D may consider itself to be in-coverage for NR sidelink communication on that frequency. The terminal devices 1E and 1F cannot detect any cell on that frequency meeting the criterion, they may consider themselves to be out-of-coverage for NR sidelink communication on that frequency. The sidelink communication between in-coverage UEs may be referred to as in-coverage scenario. The sidelink communication between in-coverage UE (e.g. the terminal device 1D) and out-of-coverage UE (e.g. the terminal device 1E) may be referred to as partial-coverage scenario. The sidelink communication between out-of-coverage UEs (e.g. the terminal devices 1E and 1F) may be referred to as out-of-coverage scenario. The in-coverage UE may acquire the SIB containing sidelink configuration information for sidelink communication.

A sidelink physical channel may correspond to a set of resource elements carrying information originating from higher layers and/or sidelink control information. The sidelink physical channels may include Physical Sidelink Shared Channel (PSSCH), Physical Sidelink Broadcast Channel (PSBCH), Physical Sidelink Control Channel (PSCCH) and Physical Sidelink Feedback Channel (PSFCH). PSCCH may indicate resource and other transmission parameters used by a UE for PSSCH. PSCCH transmission may be associated with a DM-RS. The PSSCH may transmit the TBs of data themselves, and control information for HARQ procedures and CSI feedback triggers, etc. At least 6 OFDM symbols within a slot may be used for PSSCH transmission. PSSCH transmission may be associated with a DM-RS and may be associated with a PT-RS. PSFCH may carry HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. PSBCH may occupy 9 and 5 symbols for normal and extended CP cases respectively, including the associated DM-RS.

A sidelink physical signal may correspond to a set of resource elements used by the physical layer but may not carry information originating from higher layers. The sidelink physical signals may include Demodulation reference signals (DM-RS), Channel-state information reference signal (CSI-RS), Phase-tracking reference signal (PT-RS), Sidelink primary synchronization signal (S-PSS) and Sidelink secondary synchronization signal (S-SSS). S-PSS and S-SSS may be referred to as SLSS (SideLink Synchronization Signal). Each of S-PSS and S-SSS may occupy 2 symbols and 127 subcarriers. There may be 672 unique physical-layer sidelink synchronization identities given by N\hat{ }SL_ID, where N\hat{ }SL_ID denotes SLSSIDs (SideLink Synchronization Signal IDendities). The sidelink synchronization identities are divided into two sets, id_net (i.e., the ID set for in-coverage) consisting of N\hat{ }SL_ID=0, 1, . . . , 355 and id_ooc (i.e., the ID set for out-of-coverage) consisting of N\hat{ }SL_ID=336, 337, . . . , 671. The sequences used for S-PSS and S-SSS are generated depending on the SLSSID. A UE may receive the S-PSS and S-SSS in order to acquire time and frequency synchronization with the source (e.g., a cell, another UE or Global Navigation Satellite System (GNSS)) of the synchronization signal and to detect the SLSSID of the source. Sidelink Synchronization Signal Block (S-SSB) may include SLSS and PSBCH. The S-SSB may be also referred to as S-SS/PSBCH block.

A UE capable of NR sidelink communication and SLSS/PSBCH transmission may, when transmitting NR sidelink communication, transmit sidelink SSB (i.e., SLSS and PSBCH) on the frequency used for NR sidelink communication when conditions are met. The conditions may be that the UE is in coverage on the frequency used for NR sidelink communication and has selected GNSS or the cell as synchronization reference. The conditions may be that the UE is out of coverage on the frequency used for NR sidelink communication and has no selected GNSS or no cell as synchronization reference. The conditions may be that the UE is out of coverage on the frequency used for NR sidelink communication and has selected GNSS or the cell as synchronization reference, and the frequency is included in the sidelink frequency information list (the list of one or more frequencies where a base station allows UEs to perform the sidelink transmission) provided by a cell (i.e., provided by a base station).

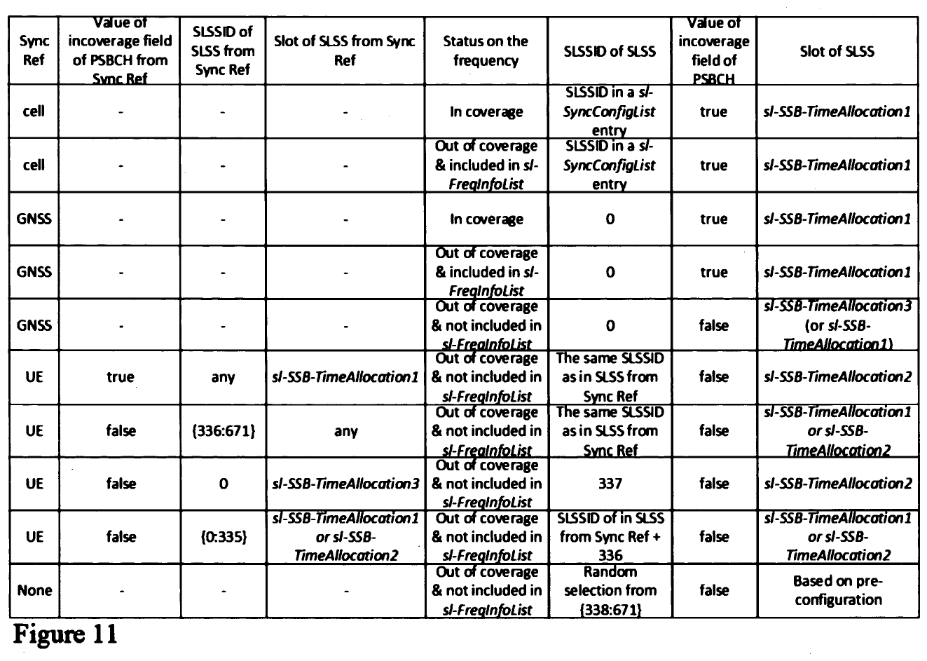

The UE may select SLSS parameters including the SLSSID and the slot in which to transmit SLSS. FIG. 11 shows the table for SLSS parameter determination. This table may specify an example of how S-SSB parameters (e.g. SLSSID of SLSS, value of inCoverage field of PSBCH, slot of SLSS) of S-SSB to be transmitted may be determined from parameters related to the received SSB, S-SSB or GNSS (e.g. Sync Ref, value of inCoverage field of PSBCH from Sync Ref, SLSSID of SLSS from Sync Ref, Slot of SLSS from Sync Ref) and status on the frequency for the sidelink communication.

When a UE transmits SLSS, the UE may select synchronization reference (Sync Ref) which is used as a reference (e.g. a reference of timing and/or frequency) for synchronization of the transmitted SLSS, where the synchronization may include the synchronization of symbol boundaries, slot boundaries and/or frame boundaries. The synchronization reference may be also referred to as a synchronization source or a synchronization reference source, and may be a cell, GNSS or UE which transmits a SLSS. If a UE does not have any of a cell, GNSS or a UE available for the synchronization, the UE may have no selected Sync Ref. The UE may also receive SLSS and PSBCH which are transmitted by the synchronization reference when the synchronization reference is another UE. The UE may acquire SLSSID of the received SLSS from the received SLSS. UE may acquire MasterInformationBlockSidelink (SL-MIB) contained in the received PSBCH. SL-MIB may include information fields named sl-TDD-Config, inCoverage, directFrameNumber, slotlndex and reservedBits. The value of directFrameNumber field may indicate the frame number in which S-SSB transmitted. The Boolean value of inCoverage field may indicate in coverage or out of coverage. More specifically, the value true may indicate that the UE transmitting the SL-MIB is in network coverage or selects GNSS timing as the synchronization reference source, while the value false may indicate that the UE transmitting the SL-MIB is out of network coverage and does not select GNSS timing as the synchronization reference source. The value of slotlndex field may indicate the slot index in which S-SSB transmitted.

If the Sync Ref is a cell and the UE transmitting S-SSB is in coverage on the frequency for the sidelink communication, SLSSID of the transmitted SLSS may be set to the SLSSID in a sl-SyncConfigList entry, the value of inCoverage field of the transmitted PSBCH may be set to true, and the slot of transmitted SLSS may be the slot indicated by sl-SSB-TimeAllocation1 which may be included in RRCReconfiguration or SIB.

If the Sync Ref is GNSS and the UE transmitting S-SSB is out of coverage on the frequency for the sidelink communication and the frequency is not indicated in sl-FreqInfoList provided in RRCReconfiguration or SIB, SLSSID of the transmitted SLSS may be set to 0, the value of inCoverage field of the transmitted PSBCH may be set to false, and the slot of transmitted SLSS may be the slot indicated by sl-SSB-TimeAllocation3 which may be included in SidelinkPreconfigNR.

If the Sync Ref is another UE and the UE transmitting S-SSB is out of coverage on the frequency for the sidelink communication and the frequency is not indicated in sl-FreqInfoList provided in RRCReconfiguration or SIB, SLSSID of the transmitted SLSS, the value of inCoverage field of the transmitted PSBCH and the slot of transmitted SLSS may depend on the combination of the value of inCoverage field of PSBCH from Sync Ref, SLSSID of SLSS from Sync Ref and Slot of SLSS from Sync Ref.

If the UE transmitting S-SSB has no Sync Ref and the UE transmitting S-SSB is out of coverage on the frequency for the sidelink communication and the frequency is not indicated in sl-FreqInfoList provided in RRCReconfiguration or SIB, SLSSID of the transmitted SLSS may be randomly selected from id_ooc, the value of inCoverage field of the transmitted PSBCH may be set to false, and the slot of transmitted SLSS may the slot indicated by sl-SSB-TimeAllocation1 or sl-SSB-TimeAllocation2 which is included in SidelinkPreconfigNR.

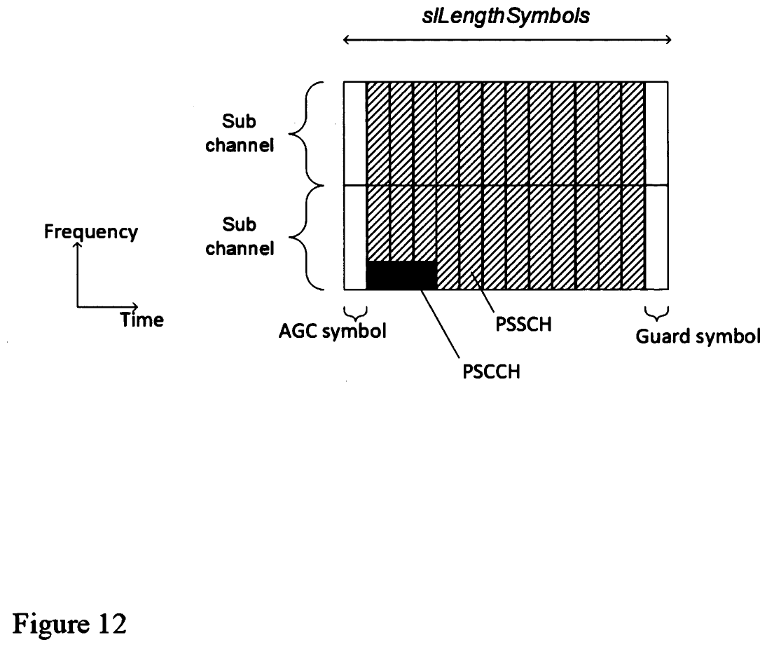

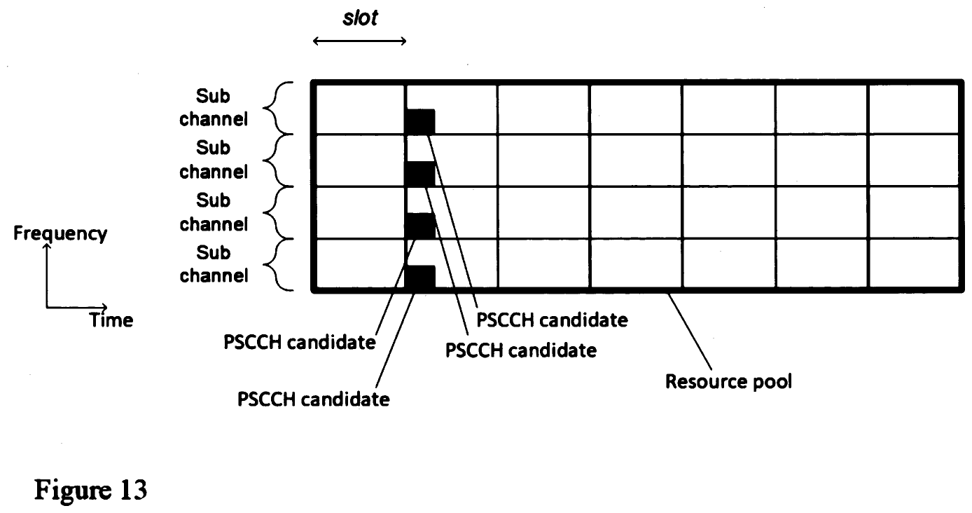

FIG. 12 shows an example of sub-channel structure for sidelink transmissions. FIG. 13 shows an example of resource pool for sidelink transmissions. A UE may be provided by SL-BWP-Config a BWP for SL transmissions (SL BWP) with numerology and resource grid. For a resource pool within the SL BWP, the UE is provided by sl-NumSubchannel a number of sub-channels where each sub-channel includes a number of contiguous RBs provided by sl-SubchannelSize. The first RB of the first sub-channel in the SL BWP may be indicated by sl-StartRB-Subchannel. Available slots for a resource pool may be provided by sl-TimeResource and may occur with a periodicity of 10240 ms. For an available slot without S-SS/PSBCH blocks, SL transmissions can start from a first symbol indicated by sl-StartSymbol and be within a number of consecutive symbols indicated by sl-LengthSymbols. For an available slot with S-SS/PSBCH blocks, the first symbol and the number of consecutive symbols is predetermined.

A UE can be provided a number of symbols in a resource pool, by sl-TimeResourcePSCCH, starting from a second symbol that is available for SL transmissions in a slot, and a number of PRBs in the resource pool, by sl-FreqResourcePSCCH, starting from the lowest PRB of the lowest sub-channel of the associated PSSCH, for a PSCCH transmission with a SideLink Control Information (SCI) format 1-A.

Each PSSCH transmission may be associated with an PSCCH transmission. That PSCCH transmission may carry the 1st stage of the SCI associated with the PSSCH transmission, and the 2nd stage of the associated SCI may be carried within the resource of the PSSCH.

A DCI may transport downlink control information for one or more cells with one RNTI.

DCI format 3_0 may be used for scheduling of NR PSCCH and NR PSSCH in one cell. The following information may be transmitted by means of the DCI format 3_0 with CRC scrambled by SL-RNTI or SL-CS-RNTI:
Resource pool index—[log₂ I] bits, where I is the number of resource pools for transmission configured by the higher layer parameter sl-TxPoolScheduling;
Time gap—3 bits determined by higher layer parameter sl-DCI-ToSL-Trans;
HARQ process number—4 bits;
New data indicator—1 bit;
Lowest index of the subchannel allocation to the initial transmission—

$$⌈ {log}_{2} ( {N}_{subChannel}^{SL} ) ⌉$$

bits;
SCI format 1—A fields including Frequency resource assignment field and Time resource assignment field;
PSFCH-to-HARQ feedback timing indicator−[log₂ N_{fb_timing}] bits, where N_{fb_timing} is the number of entries in the higher layer parameter sl-PSFCH-ToPUCCH;
PUCCH resource indicator—3 bits;
Configuration index—0 bit if the UE is not configured to monitor DCI format 3_0 with CRC scrambled by SL-CS-RNTI; otherwise 3 bits. If the UE is configured to monitor DCI format 3_0 with CRC scrambled by SL-CS-RNTI, this field is reserved for DCI format 3_0 with CRC scrambled by SL-RNTI;
Counter sidelink assignment index—2 bits;
Padding bits, if required;
If multiple transmit resource pools are provided in sl-TxPoolScheduling, zeros may be appended to the DCI format 3_0 until the payload size is equal to the size of a DCI format 3_0 given by a configuration of the transmit resource pool resulting in the largest number of information bits for DCI format 3_0. If the UE is configured to monitor DCI format 3_1 and the number of information bits in DCI format 3_0 is less than the payload of DCI format 3_1, zeros may be appended to DCI format 30 until the payload size equals that of DCI format 3_1.

DCI format 3_1 may be used for scheduling of LTE PSCCH and LTE PSSCH in one cell. The following information is transmitted by means of the DCI format 3_1 with CRC scrambled by SL Semi-Persistent Scheduling V-RNTI:
Timing offset—3 bits determined by higher layer parameter sl-TimeOffsetEUTRA;
Carrier indicator—3 bits;
Lowest index of the subchannel allocation to the initial transmission—

$$⌈ {log}_{2} ( {N}_{subchannel}^{SL} ) ⌉$$

bits;
Frequency resource location of initial transmission and retransmission;
Time gap between initial transmission and retransmission;
SL index—2 bits;
SL SPS configuration index—3 bits;
Activation/release indication—1 bit;
If the UE is configured to monitor DCI format 3_0 and the number of information bits in DCI format 3_1 is less than the payload of DCI format 3_0, zeros may be appended to DCI format 3_1 until the payload size equals that of DCI format 3_0.

SCI carried on PSCCH is a 1^{st}-stage SCI, which transports sidelink scheduling information.

SCI format 1-A is a 1^{st}-stage SCI and may be used for the scheduling of PSSCH and 2^{nd}-stage-SCI on PSSCH. The following information is transmitted by means of the SCI format 1-A:
Priority—3 bits, where value ‘000’ of Priority field corresponds to priority value ‘1’, value ‘001’ of Priority field corresponds to priority value ‘2’, and so on;
Frequency resource assignment—

$$⌈ {log}_{2} ( \frac{{N}_{subChannel}^{SL} ( {N}_{subChannel}^{SL} + 1 )}{2} ) ⌉ bits$$

when the value of the higher layer parameter sl-MaxNumPerReserve is configured to 2; otherwise

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ bits$$

when the value of the higher layer parameter sl-MaxNumPerReserve is configured to 3;
Time resource assignment—5 bits when the value of the higher layer parameter sl-MaxNumPerReserve is configured to 2; otherwise 9 bits when the value of the higher layer parameter sl-MaxNumPerReserve is configured to 3;
Resource reservation period—[log₂ Nrsv_period] bits, where Nrsv_period is the number of entries in the higher layer parameter sl-ResourceReservePeriodList, if higher layer parameter sl-MultiReserveResource is configured; 0 bit otherwise;
DMRS pattern—[log₂ Nₚₐₜₜₑᵣₙ] bits, where Nₚₐₜₜₑᵣₙ is the number of DMRS patterns configured by higher layer parameter sl-PSSCH-DMRS-TimePatternList;
2ⁿd-stage SCI format—2 bits;
Beta_offset indicator—2 bits as provided by higher layer parameter sl-BetaOffsets2ndSCI;
Number of DMRS port—1 bit;
Modulation and coding scheme—5 bits;
Additional MCS table indicator—1 bit if one MCS table is configured by higher layer parameter sl-Additional-MCS-Table; 2 bits if two MCS tables are configured by higher layer parameter sl-Additional-MCS-Table; 0 bit otherwise;
PSFCH overhead indication—1 bit if higher layer parameter sl-PSFCH-Period=2 or 4; 0 bit otherwise;
Reserved—a number of bits as: N_{reserved} bits as configured by higher layer parameter sl-NumReservedBits, with value set to zero, if higher layer parameter indicationUEBScheme2 is not configured, or if higher layer parameter indicationUEBScheme2 is configured to ‘Disabled’; (N_{reserved}−1) bits otherwise, with value set to zero;
Conflict information receiver flag—0 or 1 bit, where 1 bit if higher layer parameter indicationUEBScheme2 is configured to ‘Enabled’, where the bit value of 0 indicates that the UE cannot be a UE to receive conflict information and the bit value of 1 indicates that the UE can be a UE to receive conflict information, 0 bit otherwise;
SCI carried on PSSCH is a 2^{nd}-stage SCI, which transports sidelink scheduling information, and/or inter-UE coordination related information.

SCI format 2-A is a 2^{nd}-stage SCI and may be used for the decoding of PSSCH, with HARQ operation when HARQ-ACK information includes ACK or NACK, when HARQ-ACK information includes only NACK, or when there is no feedback of HARQ-ACK information. The following information may be transmitted by means of the SCI format 2-A:
HARQ process number—4 bits;
New data indicator—1 bit;
Redundancy version—2 bits;
Source ID—8 bits;
Destination ID—16 bits;
HARQ feedback enabled/disabled indicator—1 bit;
Cast type indicator—2 bits;
CSI request—1 bit;
SCI format 2-B is a 2^{nd}-stage SCI and may be u used for the decoding of PSSCH, with HARQ operation when HARQ-ACK information includes only NACK, or when there is no feedback of HARQ-ACK information. The following information may be transmitted by means of the SCI format 2-B:
HARQ process number—4 bits;
New data indicator—1 bit;
Redundancy version—2 bits;
Source ID—8 bits;
Destination ID—16 bits;
HARQ feedback enabled/disabled indicator—1 bit;
Zone ID—12 bits;
Communication range requirement—4 bits determined by higher layer parameter sl-ZoneConfigMCR-Index;
The UE may transmit the PSSCH in the same slot as the associated PSCCH. The minimum resource allocation unit in the time domain may be a slot. The UE may transmit the PSSCH in consecutive symbols within the slot. The UE may not be allowed to transmit PSSCH in symbols which are not configured for sidelink. A symbol may be configured for sidelink, according to higher layer parameters sl-StartSymbol and sl-LengthSymbols, where sl-StartSymbol is the symbol index of the first symbol of sl-LengthSymbols consecutive symbols configured for sidelink. Within the slot, PSSCH resource allocation may start at symbol sl-StartSymbol+1. The UE may not be allowed to transmit PSSCH in symbols which are configured for use by PSFCH, if PSFCH is configured in this slot. The UE may not be allowed to transmit PSSCH in the last symbol configured for sidelink. The UE may not be allowed to transmit PSSCH in the symbol immediately preceding the symbols which are configured for use by PSFCH, if PSFCH is configured in this slot.

The resource allocation unit in the frequency domain may be the sub-channel. The sub-channel assignment for sidelink transmission may be determined using the “Frequency resource assignment” field in the associated SCI. The lowest sub-channel for sidelink transmission may be the sub-channel on which the lowest PRB of the associated PSCCH is transmitted. If a PSSCH scheduled by a PSCCH would overlap with resources containing the PSCCH, the resources corresponding to a union of the PSCCH that scheduled the PSSCH and associated PSCCH DM-RS are not available for the PSSCH.

The mapping operation of PSSCH to REs of the assigned RBs may be done in two steps. In the first step, the complex-valued symbols corresponding to the bit for the 2nd-stage SCI in increasing order of first the index k′ over the assigned virtual resource blocks and then the index 1, starting from the first PSSCH symbol carrying an associated DM-RS and meeting all of the criteria that the corresponding resource elements in the corresponding physical resource blocks are not used for transmission of the associated DM-RS, PT-RS, or PSCCH. In the second step, the complex-valued modulation symbols not corresponding to the 2nd-stage SCI may be in increasing order of first the index k′ over the assigned virtual resource blocks, and then the index 1 with the starting position given and meeting all of the following criteria that the resource elements are not used for 2nd-stage SCI in the first step and the corresponding resource elements in the corresponding physical resource blocks are not used for transmission of the associated DM-RS, PT-RS, CSI-RS, or PSCCH.

The resource elements used for the PSCCH and/or PSSCH in the first OFDM symbol, including any DM-RS, PT-RS, or CSI-RS occurring in the first OFDM symbol, may be duplicated in the OFDM symbol (also referred to as Automatic Gain Control (AGC) symbol, which may be used for AGC purpose) immediately preceding the first OFDM symbol in the mapping. The OFDM symbol immediately following the last symbol used for PSSCH, PSFCH, or S-SSB serves as a guard symbol, which may be left unused as place holder.

AUE may monitor a set of PSCCH candidates in the configured resource pool where monitoring may imply receiving each PSCCH candidate and decoding according to the monitored SCI formats. Each of PSCCH candidates in the configured resource pool may take place on a respective sub-channel in the configured resource pool. Every single sub-channel in the resource pool may include one PSCCH candidate. If the SCI format on a PSCCH candidate is successfully decoded, the UE may consider the SCI format on PSCCH is detected. For sidelink resource allocation mode 1, a UE upon detection of SCI format 1-A on PSCCH can decode PSSCH according to the detected SCI formats 2-A and 2-B, and associated PSSCH resource configuration configured by higher layers. The UE is not required to decode more than one PSCCH at each PSCCH resource candidate. For sidelink resource allocation mode 2, a UE upon detection of SCI format 1-A on PSCCH can decode PSSCH according to the detected SCI formats 2-A and 2-B, and associated PSSCH resource configuration configured by higher layers. The UE is not required to decode more than one PSCCH at each PSCCH resource candidate.

A UE can be indicated by an SCI format scheduling a PSSCH reception to transmit a PSFCH with HARQ-ACK information to the UE that the PSSCH was transmitted, in response to the PSSCH reception. The UE transmitting PSFCH may provide HARQ-ACK information that includes ACK or NACK, or only NACK.

Downlink and/or uplink positioning is described hereafter.

Positioning functionality may provide a means to determine the geographic position and/or velocity of the UE based on measuring radio signals. The position information may be requested by and reported to a client (e.g., an application) associated with the UE, or by a client within or attached to the core network.

The NG-RAN may utilize one or more positioning methods in order to determine the position of an UE. Positioning the UE involves two main steps: signal measurements; and position estimate and optional velocity computation based on the measurements. The signal measurements may be made by the UE or by the serving ng-eNB or gNB. The basic signals measured for terrestrial position methods are typically the LTE or NR radio transmissions; however, other methods may make use of other transmissions such as general radio navigation signals including those from GNSSs. The position estimate computation may be made by the UE or by the Location Management Function (LMF) server.

The standard positioning methods for downlink and/or uplink positioning supported for NG-RAN access may include:
network-assisted GNSS methods;
observed time difference of arrival (OTDOA) positioning based on LTE signals;
enhanced cell ID methods based on LTE signals;
WLAN positioning;
Bluetooth positioning;
terrestrial beacon system (TBS) positioning;
sensor based methods:
NR enhanced cell ID methods (NR E-CID) based on NR signals;
Multi-Round Trip Time Positioning (Multi-RTT based on NR signals);
Downlink Angle-of-Departure (DL-AoD) based on NR signals;
Downlink Time Difference of Arrival (DL-TDOA) based on NR signals;
Uplink Time Difference of Arrival (UL-TDOA) based on NR signals;
Uplink Angle-of-Arrival (UL-AoA), including A-AoA and Z-AoA based on NR signals.

Separately from location service support for particular UEs, an LMF may interact with elements in the NG-RAN in order to obtain measurement information to help assist one or more position methods for all UEs. An LMF may also interact with NG-RAN node to provide assistance data information for broadcasting. An LMF can interact with any NG-RAN node reachable from any of the AMFs with signalling access to the LMF in order to provide assistance data information for broadcasting. The information can include positioning System Information Blocks (posSIBs) together with assistance information meta data, broadcast cells and broadcast periodicity.

These positioning methods may be supported in UE-based, UE-assisted/LMF-based, and NG-RAN node assisted versions. The LTE Positioning Protocol (LPP) may be terminated between a target device (the UE in the control-plane case) and a positioning server (the LMF in the control-plane case). LPP messages may be carried as transparent PDUs across intermediate network interfaces using the appropriate protocols (e.g., NAS/RRC over the NR-Uu interfaces).

Positioning assistance data can be included in positioning System Information Blocks (posSIBs). The posSIBs are carried in RRC System Information (SI) messages. The mapping of posSIBs (assistance data) to SI messages is flexibly configurable and provided to the UE in SIB1 for NG-RAN node. The UE may request posSI by means of on-demand SI request in RRC_IDLE/RRC_INACTIVE and also request posSMBs by means of on-demand SI request in RRC_CONNECTED. For each assistance data element, a separate posSIB-type may be used. Each posSIB may be ciphered by the LMF using the 128-bit Advanced Encryption Standard (AES) algorithm (with counter mode).

The measurements of DL signals/channels at the UE side for positioning are described. The DL Positioning Reference Signals (DL PRS) are defined to facilitate support of different positioning methods such as DL Time Difference Of Arrival (DL-TDOA), DL Angle of Departure (DL-AoD), multi-Round Trip Time (multi-RTT) through the following set of UE measurements DL Reference Signal Time Difference (DL RSTD), DL PRS Reference Signal Received Power (DL PRS-RSRP), and UE Rx-Tx time difference respectively. Besides DL PRS signals, UE can use SSB and CSI-RS for RRM (e.g. RSRP and RSRQ) measurements for E-CID type of positioning.

DL PRS-RSRP may be defined as the linear average over the power contributions (in [W]) of the resource elements that carry DL PRS reference signals configured for RSRP measurements within the considered measurement frequency bandwidth. DL PRS-RSRP may be applicable for RRC_CONNECTED and RRC_INACTIVE.

DL RSTD may be the DL relative timing difference between the Transmission Point (TP) j and the reference TP i, defined as T_{SubframeRxj}−T_{subframeRxi}, where T_{subframeRxj} may be the time when the UE receives the start of one subframe from TPj, and T_{subframeRxi} may be the time when the UE receives the corresponding start of one subframe from TP i that is closest in time to the subframe received from TP j. Multiple DL PRS resources can be used to determine the start of one subframe from a TP. DL RSTD may be applicable for RRC_CONNECTED and RRC_INACTIVE.

The UE Rx-Tx time difference is defined as T_{UE-RX}−T_{UE-TX}, where T_{UE-RX} is the UE received timing of downlink subframe #i from a TP, defined by the first detected path in time, and T_{UE-TX} is the UE transmit timing of uplink subframe #j that is closest in time to the subframe #i received from the TP. Multiple DL PRS or CSI-RS for tracking resources, as instructed by higher layers, can be used to determine the start of one subframe of the first arrival path of the TP. UE Rx-Tx time difference may be applicable for RRC_CONNECTED and RRC_INACTIVE.

DL PRS reference signal received path power (DL PRS-RSRPP), may be defined as the power of the linear average of the channel response at the i-th path delay of the resource elements that carry DL PRS signal configured for the measurement, where DL PRS-RSRPP for the 1st path delay is the power contribution corresponding to the first detected path in time. DL PRS-RSRPP may be applicable for RRC_CONNECTED and RRC_INACTIVE.

The measurements of UL signals/channels at the gNB side for positioning are described. The periodic, semipersistent and aperiodic transmission of SRS may be used for gNB UL Relative Time of Arrival (gNB UL RTOA), UL SRS-RSRP, UL Angle Of Arrival (UL-AoA) measurements to facilitate support of UL TDOA and UL AoA positioning methods.

The UL Relative Time of Arrival (T_{UL-RTOA}) may be the beginning of subframe i containing SRS received in Reception Point (RP) j, relative to the RTOA Reference Time. The UL RTOA reference time is defined as T₀+t_{SRS}, where T₀ is the nominal beginning time of SFN 0 provided by SFN Initialization Time, and t_{SRS}=(10n_{f}+n_{sf})×10⁻³, where n_{f} and n_{sf} are the system frame number and the subframe number of the SRS, respectively. Multiple SRS resources can be used to determine the beginning of one subframe containing SRS received at a RP.

The gNB Rx-Tx time difference may be defined as T_{gNB-RX}−T_{gNB-TX}, where T_{gNB-RX} is the Transmission and Reception Point (TRP) received timing of uplink subframe #i containing SRS associated with UE, defined by the first detected path in time, and T_{gNB-TX} is the TRP transmit timing of downlink subframe #j that is closest in time to the subframe #i received from the UE. Multiple SRS resources can be used to determine the start of one subframe containing SRS.

UL Angle of Arrival (UL AoA) may be defined as the estimated azimuth angle and vertical angle of a UE with respect to a reference direction, wherein the reference direction is defined: in the global coordinate system (GCS), wherein estimated azimuth angle is measured relative to geographical North and is positive in a counter-clockwise direction and estimated vertical angle is measured relative to zenith and positive to horizontal direction; in the local coordinate system (LCS), wherein estimated azimuth angle is measured relative to x-axis of LCS and positive in a counter-clockwise direction and estimated vertical angle is measured relative to z-axis of LCS and positive to x-y plane direction. The UL AoA is determined at the gNB antenna for an UL channel corresponding to this UE.

UL SRS reference signal received power (UL SRS-RSRP) may be defined as linear average of the power contributions (in [W]) of the resource elements carrying sounding reference signals (SRS). UL SRS RSRP shall be measured over the configured resource elements within the considered measurement frequency bandwidth in the configured measurement time occasions.

UL SRS reference signal received path power (UL SRS-RSRPP) may be defined as the power of the linear average of the channel response at the i-th path delay of the resource elements that carry the received UL SRS signal configured for the measurement, where UL SRS-RSRPP for 1st path delay is the power contribution corresponding to the first detected path in time.

Sidelink positioning is described hereafter.

Positioning functionality may provide a means to determine the geographic position and/or velocity of the UE based on measuring radio signals. The position information may be requested by and reported to a client (e.g., an application) associated with the UE, or by a client within or attached to the core network.

For sidelink positioning in Out-of-coverage scenario, positioning functionality may work between UEs and NG-RAN or core network and/or LMF may not be involved.

The standard positioning methods for sidelink positioning may include:
observed time difference of arrival (OTDOA) positioning based on LTE signals;
enhanced cell ID methods based on LTE signals;
WLAN positioning;
Bluetooth positioning;
terrestrial beacon system (TBS) positioning;
sensor based methods:
NR enhanced cell ID methods (NR E-CID) based on NR signals;
Sidelink Multi-Round Trip Time Positioning (SL-M-RTT based on NR signals) with multiple anchor UEs;
Sidelink Multi-Angle-of-Departure (SL-M-AoD) based on NR signals with multiple anchor UEs;
Sidelink Multi-Angle-of-Arrival (SL-M-AoA) based on NR signals with multiple anchor UEs;
Sidelink Time Difference of Arrival (SL-TDOA) based on NR signals with multiple anchor UEs;
Sidelink Single-Angle-of-Departure (SL-S-AoD) based on NR signals with a single anchor UE;
Sidelink Single-Angle-of-Arrival (SL-S-AoA) based on NR signals with a single anchor UE;
Sidelink Single-Round Trip Time Positioning (SL-S-RTT) based on NR signals with a single anchor UE;
Sidelink Single Round Trip Time and Angle-of-Departure (SL-S-RTT+AoD) based on NR signals with a single anchor UE;
Sidelink Single Round Trip Time and Angle-of-Arrival (SL-S-RTT+AoA) based on NR signals with a single anchor UE.

The measurements of SL signals/channels at the UE side for positioning are described. The SL Positioning Reference Signals (SL PRS, SL-PRS) and/or the periodic, semipersistent and aperiodic transmission of SL SRS (SL-SRS) may be defined to facilitate support of different positioning methods such as SL-TDOA, SL-M-AoD, SL-M-AoA, SL-M-RTT, SL-S-AoD, SL-S-AoA, SL-S-RTT, SL-S-RTT+AoD, SL-S-RTT+AoA through the following set of UE measurements such as SL Reference Signal Time Difference (SL RSTD), SL PRS-RSRP, SL SRS-RSRP, SL PRS-RSRPP, SL SRS-RSRPP, UE SL Relative Time of Arrival (UE SL RTOA), SL AoA and/or UE Rx-Tx time difference. Besides SL PRS signals and/or SL SRS, UE can use S-SS/PSBCH block and CSI-RS for RRM (e.g. RSRP and RSRQ) measurements for E-CID type of positioning.

SL PRS may be SL reference signal(s) used for sidelink positioning. The sequence of the SL PRS may be defined using pseudo-random sequence. The pseudo-random sequence may be initialized using slot number, sidelink PRS sequence ID (e.g. 0, 1, . . . , 4095) which is given by the higher-layer parameter sl-PRS-SequenceID, and the OFDM symbol within the slot to which the sequence is mapped.

SL PRS may be mapped a sidelink PRS resource configured. The defined SL PRS sequence may be mapped to resource elements within the resource block occupied by the sidelink PRS resource configured and to symbols not used by any S-SS/PBSCH block.

The first symbol of the sidelink PRS within a slot may be given by the higher-layer parameter (can be in PC5-RRC message) sl-PRS-ResourceSymbolOffset.

The size of the sidelink PRS resource in the time domain L_{SL-PRS} is given by the higher-layer parameter sl-PRS-NumSymbols. The candidate values for the L_{SL-PRS} may be 2, 4, 6, 12.

The comb size K^{SL-PRS}_{comb} for the SL PRS frequency resource may be given by the higher-layer parameter sl-PRS-CombSizeN. The comb size K^{SL-PRS}_{comb} defines subcarrier interval the SL PRS is assigned. The candidate values for the comb size K^{SL-PRS}_{comb} may be 2, 4, 6, 12.

The resource-element offset for the SL PRS frequency resource k^{SL-PRS}_{offset} may be obtained from the higher-layer parameter sl-PRS-CombSizeN-AndReOffset.

For a sidelink PRS resource in a sidelink PRS resource set, the UE shall assume the sidelink PRS resource being transmitted when the slot and frame number fulfil a condition. The condition may be defined by the periodicity for SL PRS, slot offset for SL PRS, the sidelink PRS resource slot offset, the repetition factor for SL PRS, the muting repetition factor for SL PRS and/or the time gap for SL PRS, which are given by the higher-layer parameters, respectively.

SL SRS may be SL reference signal(s) used for sidelink positioning. SL SRS may also be referred to as SL PRS or SL-PRS.

The resource for the SL SRS (sidelink SRS resource) may be configured by the higher-layer parameter sl-SRS-Resource or the sl-SRS-PosResource.

The number of antenna ports for the SL SRS may be given by the higher-layer parameter nrofSL-SRS-Ports if configured, otherwise 1.

The number of consecutive OFDM symbols for the SL SRS may be given by the field nrofSymbols contained in the higher-layer parameter resourceMapping.

The starting position in the time domain for the SL SRS may be given by the symbol offset l_{offset} which counts symbols backwards from the end of the slot and can be the value range from 0 to 13. The l_{offset} may be given by the field startPosition contained in the higher layer parameter resourceMapping.

The frequency-domain starting position of SL SRS may be configured by the field in higher-layer parameter sl-SRS-Resource or the sl-SRS-PosResource.

The sequence of the SL SRS may be defined using Zadoff-Chu sequence with cyclic shift. For sequence generation of the SL SRS for positioninig, SRS sequence ID n^{SRS}_{ID} may be used. SRS sequence ID may also be referred to as SL PRS sequence ID.

SL PRS-RSRP may be defined as the linear average over the power contributions (in [W]) of the resource elements that carry SL PRS reference signals configured for RSRP measurements within the considered measurement frequency bandwidth.

SL PRS-RSRPP may be defined as the power of the linear average of the channel response at the i-th path delay of the resource elements that carry SL PRS signal configured for the measurement, where SL PRS-RSRPP for the 1st path delay is the power contribution corresponding to the first detected path in time.

SL SRS-RSRP may be defined as linear average of the power contributions (in [W]) of the resource elements carrying SL SRS. SL SRS RSRP shall be measured over the configured resource elements within the considered measurement frequency bandwidth in the configured measurement time occasions.

SL SRS-RSRPP may be defined as the power of the linear average of the channel response at the i-th path delay of the resource elements that carry the received SL SRS signal configured for the measurement, where SL SRS-RSRPP for 1st path delay is the power contribution corresponding to the first detected path in time

SL RSTD may be the SL relative timing difference between the Transmission Point (TP) (can be anchor UE, peer UE) j and the reference TP (can be reference anchor UE, peer UE) i, defined as T_{SubframeRxj}−T_{SubframeRxi}, where T_{SubframeRxj} may be the time when the UE receives the start of one subframe from TP j, and T_{SubframeRxi} may be the time when the UE receives the corresponding start of one subframe from TP i that is closest in time to the subframe received from TP j. Multiple SL PRS resources can be used to determine the start of one subframe from a TP.

SL Relative Time of Arrival (T_{UL-RTOA}) may be the beginning of subframe i containing SL SRS received in RP (can be anchor UE, peer UE)j, relative to the RTOA Reference Time. The SL RTOA reference time is defined as T₀+t_{SRS}, where T₀ is the nominal beginning time of SFN (can be direct frame number (DFN)) 0 provided by SFN Initialization Time, and t_{SRS}=(10n_{f}+n_{sf})×10⁻³, where n_{f} and n_{sf} are the system frame number and the subframe number of the SL SRS, respectively. Multiple SL SRS resources can be used to determine the beginning of one subframe containing SL SRS received at a RP.

SL AoA may be defined as the estimated azimuth angle and vertical angle of a UE with respect to a reference direction, wherein the reference direction is defined: in the GCS, wherein estimated azimuth angle is measured relative to geographical North and is positive in a counter-clockwise direction and estimated vertical angle is measured relative to zenith and positive to horizontal direction; in the LCS, wherein estimated azimuth angle is measured relative to x-axis of LCS and positive in a counter-clockwise direction and estimated vertical angle is measured relative to z-axis of LCS and positive to x-y plane direction. The SL AoA is determined at the anchor UE antenna for a SL channel corresponding to this UE.

The UE Rx-Tx time difference is defined as T_{UE-RX}−T_{UE_RX}, where T_{UE-RX} is the UE received timing of subframe #i from a TP (can be anchor UE, peer UE), defined by the first detected path in time, and T_{UE-TX} is the UE transmit timing of subframe #j that is closest in time to the subframe #i received from the TP. Multiple SL PRS, SL SRS or CSI-RS for tracking resources, as instructed by higher layers, can be used to determine the start of one subframe of the first arrival path of the TP.

For SL positioning method, pre-configured SL positioning reference signal (SL PRS) transmission may be performed by a UE, and the SL PRS may be measured by another UE. The pre-configured SL PRS may be a SL PRS of which some of or all of the parameters are pre-configured in the UE which transmits the SL PRS. The pre-configuration may be stored in the memories in the UE even before an initial cell selection. The pre-configuration may be stored in SIM in the UE. The pre-configured SL PRS may be also referred to as always-on SL PRS.

The pre-configuration parameters may include the sidelink service ID corresponding to SL PRS transmission, which means this sidelink service ID indicates that the sidelink service to be initiated is SL PRS transmission. Additionally or alternatively, the pre-configuration parameters may include a list of PRMNs and/or RATs in which the UE is authorized to transmit SL PRS when the UE is served by the NR base station. Each entry of the list may contain a PLMN ID and/or RATs in which the UE is authorized to transmit the SL PRS. Additionally or alternatively, the pre-configuration parameters may include an indication of whether the UE is authorized to transmit SL PRS when the UE is not served by any base station. Additionally or alternatively, the pre-configuration parameters may include a list of NR sidelink frequencies for SL PRS transmission. Each entry of the list may contain the NR sidelink frequency with associated geographical area. Additionally or alternatively, the pre-configuration parameters may include a list of destination layer-2 IDs for SL PRS transmission.

There may be pre-configured RRC parameters for the SL PRS transmission. The pre-configuration RRC parameters may include a list of frequency configurations for SL PRS transmission. Each entry of the frequency configurations may include some or all of SCS configuration, absolute frequency of Point A, absolute frequency of SSB, a list of BWP(s). Each entry of the list of BWP(s) may includes resource pool configuration for the SL PRS transmission in the concerned BWP. Additionally or alternatively, the pre-configuration RRC parameters may include a priority of SL PRS. Additionally or alternatively, the pre-configuration RRC parameters may include TDD configuration.

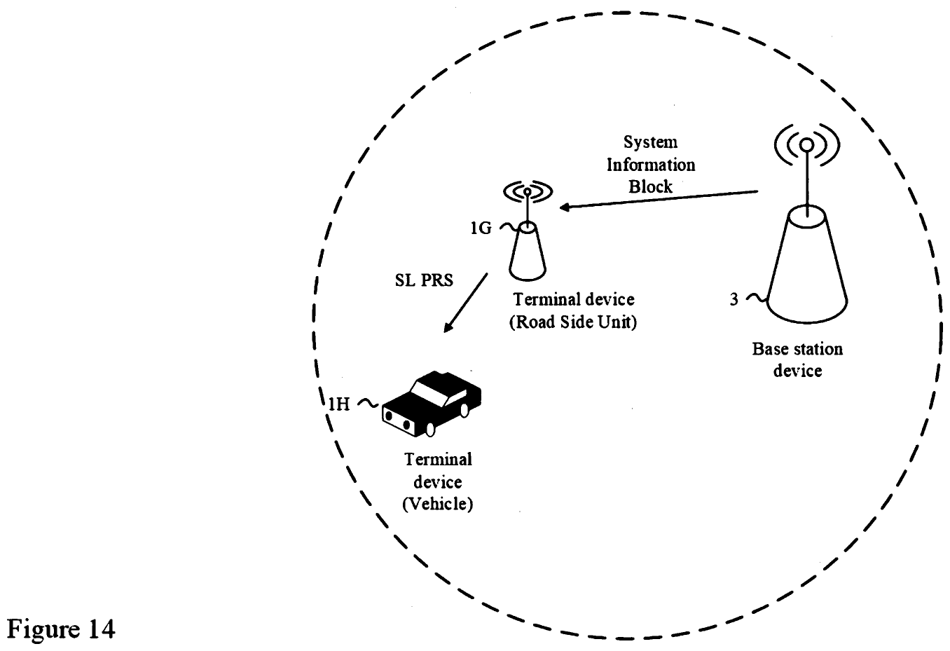

FIG. 14 is a conceptual diagram of a positioning system using sidelink signal. In FIG. 14, the positioning system using sidelink signal may include terminal device 1G and 1H and a base station device 3 (BS #3: Base station #3). The terminal devices 1G and 1H and the base station device 3 may have the same functions as of the terminal devices 1D and 1E and the base station device 3 in FIG. 9, respectively. The terminal device 1G may be a terminal device which stores the pre-configuration of the SL PRS transmission. The terminal device 1G may be Road Side Unit (RSU) type of terminal device but not limited to this type. The terminal device 1H may be a terminal device which is configured or pre-configured to perform a measurement of the SL PRS. The terminal device 1H may be Vehicle type of terminal device but not limited to this type. Terminal devices 1G and 1H may be also referred to as a terminal device 1 or a UE.

The terminal device 1G may determines that it is in-coverage. More specifically, if the terminal device 1G detects at least one cell on the frequency which it is pre-configured to perform SL PRS transmission on fulfilling the cell selection criterion (e.g. a comparison of RSRP-based cell selection reception level value with a threshold value and/or a comparison of RSRQ-based cell selection quality value with a threshold value), it may consider itself to be in-coverage for the SL PRS transmission on that frequency. If the terminal device 1G cannot detect any cell on that frequency meeting the cell selection criterion, it may consider itself to be out-of-coverage for SL PRS on that frequency. The cell selection criterion may be the same as for the cell selection criterion for sidelink communications. Similarly, the terminal device 1H may determines that it is in-coverage.

The terminal device 1G may receive SL PRS related System Information Block from the base station 3. The SL PRS related System Information Block may be also referred to as SystemInformationBlockTypeXX, where XX may be replaced by a certain integer such that the name SystemInformationBlockTypeXX does not collide with the existing System Information Block in NR. The SL PRS related System Information Block may include information indicating whether or not the SL PRS transmission based on the pre-configuration is permitted in the cell that the base station device 3 manages. Alternatively or additionally, The SL PRS related System Information Block may include information indicating a resource pool for SL PRS transmission in the cell that the base station device 3 manages. The terminal device 1G may receive SystemInformationBlockType1 from the base station 3, and the SystemInformationBlockType1 may indicate that SystemInformationBlockTypeXX is provided for the cell.

When the terminal device 1G is in-coverage for the SL PRS transmission and the terminal device 1G has received SystemInformationBlockTypeXX, the terminal device 1G may performs the first procedure of the SL PRS transmission according to SystemInformationBlockTypeXX. The first procedure may include the step that the resource for the SL PRS transmission is selected from the resource pool which is indicated by the SystemInformationBlockTypeXX.

Alternatively or additionally, the first procedure may include determining whether to perform the transmission of SL-PRS in the resource pool further in accordance with a sensing result on the resource pool. More specifically, at least if PSSCH-RSRP over the DM-RS resource elements for the PSSCH in the resource pool is higher than a threshold value, SL PRS transmission in the resource within the resource pool may not be performed. At least if PSSCH-RSRP over the DM-RS resource elements for the PSSCH in the resource pool is lower than or equal to the threshold value, SL PRS transmission in the resource within the resource pool may be performed. Alternatively or additionally, at least if PSCCH-RSRP over the DM-RS resource elements for the PSCCH in the resource pool is higher than a threshold value, SL PRS transmission in the resource within the resource pool may not be performed. At least if PSCCH-RSRP over the DM-RS resource elements for the PSCCH in the resource pool is lower than or equal to the threshold value, SL PRS transmission in the resource within the resource pool may be performed. Alternatively or additionally, at least if RSRP over the SL PRS resource elements in the resource pool is higher than a threshold value, SL PRS transmission in the resource within the resource pool may not be performed. At least if RSRP over the SL PRS resource elements in the resource pool is lower than or equal to the threshold value, SL PRS transmission in the resource within the resource pool may be performed.

Alternatively or additionally, the first procedure may include determining whether to perform the transmission of SL-PRS in the resource pool further in accordance with whether to detect Sidelink System Information Block from another UE. More specifically, at least if Sidelink System Information Block from another UE is detected in the frequency, the SL PRS transmission in the frequency may not be performed. At least if Sidelink System Information Block from another UE is not detected in the frequency, the SL PRS transmission in the frequency may be performed.

Alternatively or additionally, the first procedure may include determining whether to perform the transmission of SL-PRS in the resource pool further in accordance with whether to detect SL PRS related Sidelink System Information Block from another UE. More specifically, at least if SL PRS related Sidelink System Information Block from another UE is detected in the frequency, the SL PRS transmission in the frequency may be performed according to the information included in SL PRS related Sidelink System Information Block and/or the information included in the SystemInformationBlockTypeXX. At least if SL PRS related Sidelink System Information Block from another UE is not detected in the frequency and if SL SSB is not detected in the frequency, the SL PRS transmission in the frequency may be performed. At least if SL PRS related Sidelink System Information Block from another UE is not detected in the frequency and if SL SSB is detected in the frequency, the SL PRS transmission in the frequency may not be performed according to the SystemInformationBlockTypeXX.

Alternatively or additionally, the first procedure may include select, when the dedicated RRC configuration is acquired, a resource for the transmission of SL-PRS from a resource pool which is indicated by the dedicated RRC configuration, where dedicated RRC configuration may be received from the base station. In this case, the resource poos indicated by SystemInformationBlockTypeXX may not be used, and the resource poos indicated by the pre-configuration may not be used.

Alternatively or additionally, the first procedure may include determining (selecting) a SL PRS sequence ID for the SL PRS transmission. SL PRS sequence ID may be an ID used in sequence generation for SL PRS. The value of SL PRS sequence ID may be used in an equation for deriving SL PRS sequence. Different SL PRS sequence IDs may lead to different sequences. There are the pre-determined number (e.g., 1024, 65536, etc) of SL PRS sequence IDs. SystemInformationBlockTypeXX and/or the dedicated parameters may indicates a set of SL PRS sequence IDs. When a set of SL PRS sequence IDs are indicated, the terminal device 1G may select a SL PRS sequence ID from the indicated set of SL PRS sequence IDs. Alternatively or additionally, the SL PRS sequence IDs may be divided into multiple sets (e.g. two sets) of sequence IDs. One of the sets may corresponding to the SL PRS sequences for in-coverage. Another one of the sets may corresponding to the SL PRS sequences for out-of-coverage. When the terminal device 1G is in-coverage, it may select a SL PRS sequence ID from the set of SL PRS sequence IDs for in-coverage. The selection may be random selection.

Alternatively or additionally, the first procedure may include determining (selecting) a SL PRS resource for the SL PRS transmission from one or more resources within the resource pool indicated by SystemInformationBlockTypeXX or by the dedicated parameters. The selection may be random selection.

Alternatively or additionally, the first procedure may include determining (selecting) a SL PRS resource pool for the SL PRS transmission from one or more resource pools indicated by SystemInformationBlockTypeXX or by the dedicated parameters. The selection may be random selection.

When the terminal device 1H is in-coverage for the SL PRS measurement and the terminal device 1H has received SystemInformationBlockTypeXX, the terminal device 1H may performs the procedure of the SL PRS measurement according to SystemInformationBlockTypeXX. The procedure may include the step to the resource pool for the SL PRS measurement based on the SystemInformationBlockTypeXX. More specifically, the terminal device 1H may determine the resource pool indicated by SystemInformationBlockTypeXX as the resource pool for SL PRS monitoring (SL PRS detection attempts) and/or SL PRS measurement.

When the terminal device 1H is in-coverage for the SL PRS measurement and the terminal device 1H has received the dedicated RRC configuration (or upper-layer configuration) which includes the configuration of SL PRS measurement, the terminal device 1H may performs the procedure of the SL PRS measurement according to the dedicated RRC configuration (or upper-layer configuration). The procedure may include the step to the resource pool for the SL PRS measurement based on the dedicated RRC configuration (or upper-layer configuration). More specifically, the terminal device 1H may determine the resource pool indicated by the dedicated RRC configuration (or upper-layer configuration) as the resource pool for SL PRS monitoring (SL PRS detection attempts) and/or SL PRS measurement.

When the terminal device 1G is in-coverage for the SL PRS transmission but the terminal device 1G does not receive SystemInformationBlockTypeXX, the terminal device 1G may not performs the SL PRS transmission in this frequency. Alternatively or additionally, when the terminal device 1G is in-coverage for the SL PRS transmission and the terminal device 1G received SystemInformationBlockType1 which indicates that SystemInformationBlockTypeXX is not provided for this cell, the terminal device 1G may not performs the SL PRS transmission in this frequency.

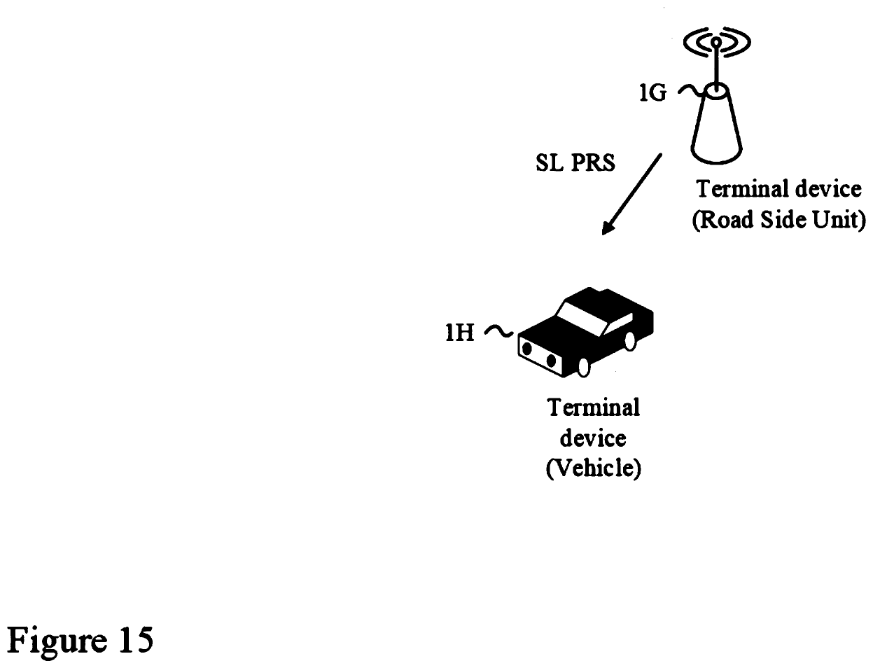

FIG. 15 is a conceptual diagram of a positioning system using sidelink signal. In FIG. 15, the positioning system using sidelink signal may include terminal device 1G and 1H. The terminal devices 1G and 1H may have the same functions as of the terminal devices 1E and 1F in FIG. 9, respectively. The terminal devices 1G and 1H may be the same terminal devices as the terminal devices 1G and 1H in FIG. 14, respectively. The terminal device 1G may be a terminal device which stores the pre-configuration of the SL PRS transmission. The terminal device 1G may be Road Side Unit (RSU) type of terminal device but not limited to this type. The terminal device 1H may be a terminal device which is configured or pre-configured to perform a measurement of the SL PRS. The terminal device 1H may be Vehicle type of terminal device but not limited to this type. Terminal devices 1G and 1H may be also referred to as a terminal device 1 or a UE.

The terminal device 1G may determines that it is out-of-coverage. The terminal device 1H may also determines that it is out-of-coverage.

When the terminal device 1G is out-of-coverage for the SL PRS transmission, the terminal device 1G may performs the second procedure of the SL PRS transmission according to the pre-configuration. The second procedure may include the step that the resource for the SL PRS transmission is selected from the resource pool which is indicated by the pre-configuration.

Alternatively or additionally, the second procedure may include determining whether to perform the transmission of SL-PRS in the resource pool further in accordance with a sensing result on the resource pool.

Alternatively or additionally, the second procedure may include determining whether to perform the transmission of SL-PRS in the resource pool further in accordance with whether to detect Sidelink System Information Block from another UE. More specifically, at least if Sidelink System Information Block from another UE is detected in the frequency, the SL PRS transmission in the frequency may not be performed. At least if Sidelink System Information Block from another UE is not detected in the frequency, the SL PRS transmission in the frequency may be performed.

Alternatively or additionally, the second procedure may include determining whether to perform the transmission of SL-PRS in the resource pool further in accordance with whether to detect SL PRS related Sidelink System Information Block from another UE. More specifically, at least if SL PRS related Sidelink System Information Block from another UE is detected in the frequency, the SL PRS transmission in the frequency may be performed according to the information included in SL PRS related Sidelink System Information Block. At least if SL PRS related Sidelink System Information Block from another UE is not detected in the frequency and if SL SSB is not detected in the frequency, the SL PRS transmission in the frequency may be performed. At least if SL PRS related Sidelink System Information Block from another UE is not detected in the frequency and if SL SSB is detected in the frequency, the SL PRS transmission in the frequency may not be performed according to the pre-configuration.

Alternatively or additionally, the second procedure may include determining (selecting) a SL PRS sequence ID for the SL PRS transmission. The pre-configuration may indicates a set of SL PRS sequence IDs. When a set of SL PRS sequence IDs are indicated, the terminal device 1G may select a SL PRS sequence ID from the indicated set of SL PRS sequence IDs. Alternatively or additionally, when the terminal device 1G is out-of-coverage, it may select a SL PRS sequence ID from the set of SL PRS sequence IDs for out-of-coverage. The selection may be random selection.

Alternatively or additionally, the second procedure may include determining (selecting) a SL PRS resource for the SL PRS transmission from one or more resources within the resource pool indicated by the pre-configuration.

Alternatively or additionally, the second procedure may include determining (selecting) a SL PRS resource pool for the SL PRS transmission from one or more resource pools indicated by the pre-configuration.

When the terminal device 1H is out-of-coverage for the SL PRS measurement, the terminal device 1H may performs the procedure of the SL PRS measurement according to the pre-configuration. The procedure may include the step to the resource pool for the SL PRS measurement based on the pre-configuration. More specifically, the terminal device 1H may determine the resource pool indicated by the pre-configuration as the resource pool for SL PRS monitoring (SL PRS detection attempts) and/or SL PRS measurement.

As described above, the terminal device 1G may select the procedure for SL PRS transmission based on one or more of: whether the terminal device 1G is in-coverage or out-of-coverage; whether the terminal device 1G receives SystemInformationBlockTypeXX or not; and whether the received SystemInformationBlockTypeXX includes certain information (e.g., information indicating that SL PRS transmission is permitted, the information indicating resource pools for SL PRS, etc) or not.

Before the terminal device 1G transmits the SL PRS, the terminal device 1G may perform sensing of other SL PRS transmissions from other devices.

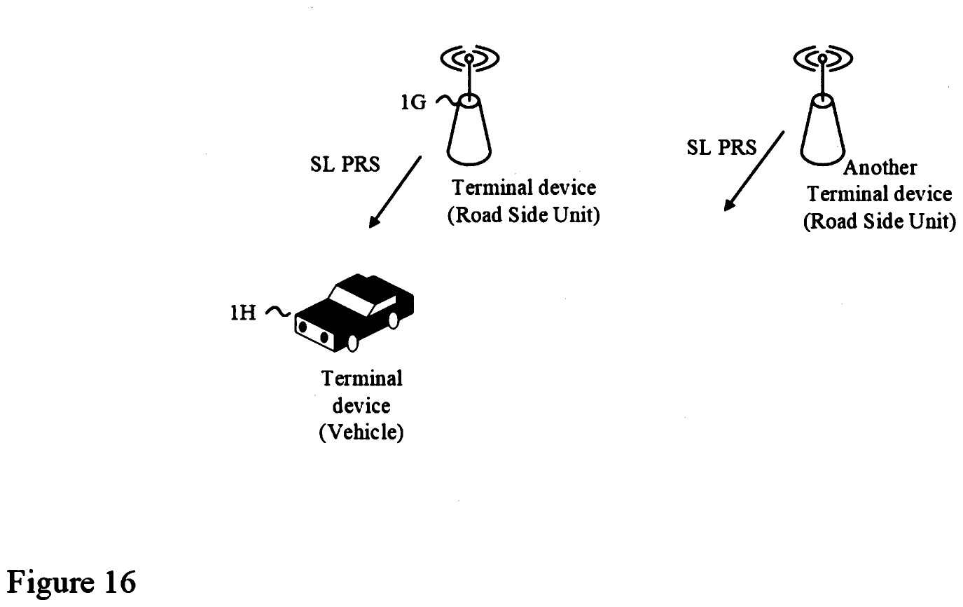

FIG. 16 is a conceptual diagram of a positioning system using sidelink signal. In FIG. 16, the positioning system using sidelink signal may include terminal device 1G and 1H. The terminal devices 1G and 1H may be the same terminal devices as the terminal devices 1G and 1H in FIG. 14, respectively. Alternatively or additionally, the terminal devices 1G and 1H may be the same terminal devices as the terminal devices 1G and 1H in FIG. 15, respectively. Before the terminal device 1G transmits the SL PRS, another terminal device that is located nearby the terminal device 1G has been transmitting another SL PRS.

When the terminal device 1G detects SL PRS(s) from other device(s), the terminal device may select a different SL PRS sequence ID from the one(s) used by the detected SL PRS(s). The terminal device 1G may transmit the SL PRS of which the sequence is generated by using the selected SL PRS sequence ID. If there is no remaining SL PRS sequence ID, the terminal device 1G may not perform the SL PRS transmission.

Alternatively or additionally, when the terminal device 1G detects SL PRS(s) from other device(s), the terminal device may select a different SL PRS resource from the one(s) used by the detected SL PRS(s). When the terminal device 1G detects SL PRS(s) from other device(s), the terminal device may select the SL PRS resource which does not overlap with the resource(s) used by the detected SL PRS(s). The terminal device 1G may transmit the SL PRS on the selected SL PRS resource. If there is no remaining SL PRS resource, the terminal device 1G may not perform the SL PRS transmission.

Alternatively or additionally, when the terminal device 1G detects SL PRS(s) from other device(s), the terminal device may select a different sub-channel from the one(s) used by the detected SL PRS(s). The terminal device 1G may transmit the SL PRS on the selected SL PRS resource. If there is no remaining sun-channel, the terminal device 1G may not perform the SL PRS transmission.

Alternatively or additionally, when the terminal device 1G detects SL PRS(s) from other device(s), the terminal device may select a different SL PRS resource pool from the one(s) used by the detected SL PRS(s). The terminal device 1G may transmit the SL PRS on the selected SL PRS resource pool. If there is no remaining SL PRS resource pool, the terminal device 1G may not perform the SL PRS transmission.

Alternatively or additionally, when the terminal device 1G detects SL PRS(s) from other device(s), the terminal device may select a different frequency from the one(s) used by the detected SL PRS(s). The terminal device 1G may transmit the SL PRS on the selected frequency. If there is no remaining frequency, the terminal device 1G may not perform the SL PRS transmission.

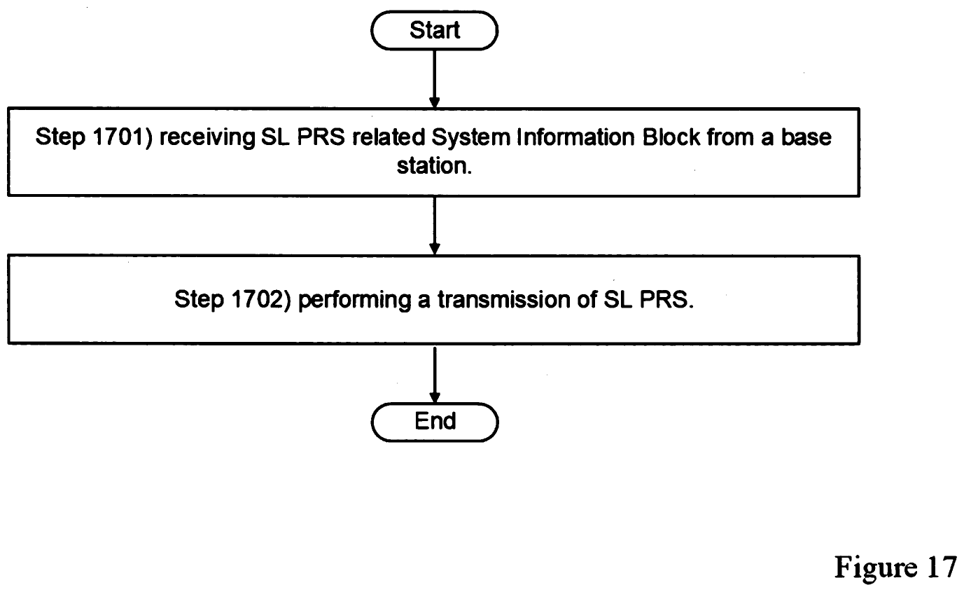

FIG. 17 shows an example of a method for a UE #1. The method may comprise receiving SL PRS related System Information Block from a base station (Step 1701). The method may also comprise performing a transmission of SL PRS (Step S1702). When the UE is in-coverage for the transmission of the SL-PRS, the UE may perform the first procedure of the transmission of the SL-PRS according to SystemInformationBlockTypeXX. When out-of-coverage for the transmission of the SL-PRS, the UE may perform the second procedure of the transmission of the SL-PRS according to pre-configuration.

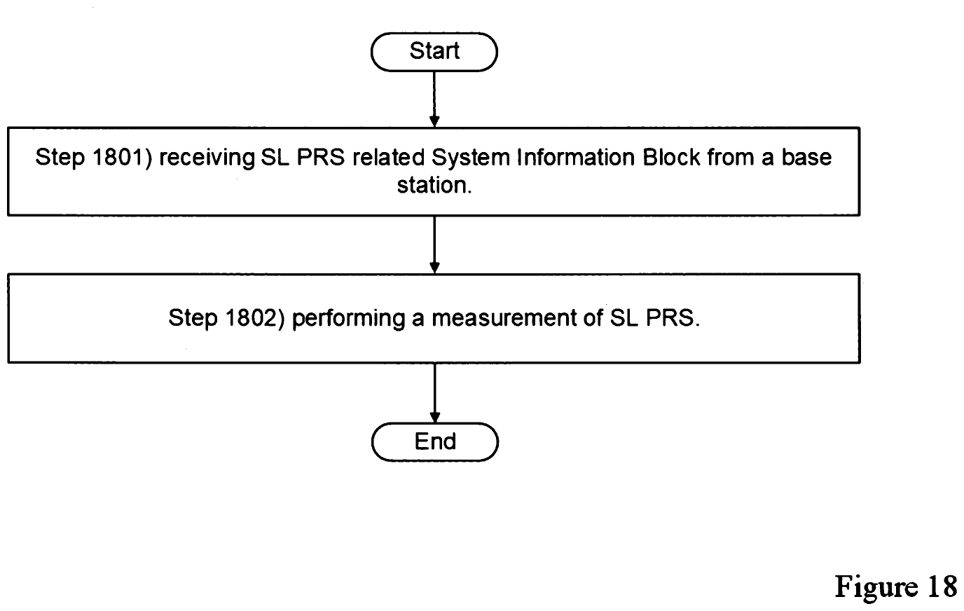

FIG. 18 shows an example of a method for a UE #1. The method may comprise receiving SL PRS related System Information Block from a base station (Step 1801). The method may also comprise performing a measurement of SL PRS (Step S1802). When the UE is in-coverage for the measurement of the SL-PRS, the UE may perform the first procedure of the measurement of the SL-PRS according to SystemInformationBlockTypeXX. When out-of-coverage for the measurement of the SL-PRS, the UE may perform the second procedure of the measurement of the SL-PRS according to pre-configuration.

Each of a program running on the base station device and the terminal device according to an aspect of the present invention may be a program that controls a Central Processing Unit (CPU) and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

Note that the terminal device 1 and the base station device 3 according to the above-described embodiment may be partially achieved by a computer. In this case, this configuration may be realized by recording a program for realizing such control functions on a computer-readable recording medium and causing a computer system to read the program recorded on the recording medium for execution.

Note that it is assumed that the “computer system” mentioned here refers to a computer system built into the terminal device 1 or the base station device 3, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the base station device 3 according to the above-described embodiment may be achieved as an aggregation (an device group) including multiple devices. Each of the devices configuring such an device group may include some or all of the functions or the functional blocks of the base station device 3 according to the above-described embodiment. The device group may include each general function or each functional block of the base station device 3. Furthermore, the terminal device 1 according to the above-described embodiment can also communicate with the base station device as the aggregation.

Furthermore, the base station device 3 according to the above-described embodiment may serve as an Evolved Universal Terrestrial Radio Access Network (E-UTRAN) and/or NG-RAN (Next Gen RAN, NR-RAN). Furthermore, the base station device 3 according to the above-described embodiment may have some or all of the functions of a node higher than an eNodeB or the gNB.

Furthermore, some or all portions of each of the terminal device 1 and the base station device 3 according to the above-described embodiment may be typically achieved as an LSI which is an integrated circuit or may be achieved as a chip set. The functional blocks of each of the terminal device 1 and the base station device 3 may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

Furthermore, according to the above-described embodiment, the words/parameters described by Italic may be RRC parameter, higher layer parameter, PC5-RRC parameter and/or preconfigured parameter.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

1. A user equipment (UE) comprising:
higher-layer processing circuitry configured to receive SystemInformationBlockTypeXX (SL PRS related System Information Block) from a base station;
transmission circuitry configured to perform a transmission of sidelink positioning reference signal (SL-PRS),
wherein
when the UE is in-coverage for the transmission of the SL-PRS, the UE performs a first procedure of the transmission of the SL-PRS according to SystemInformationBlockTypeXX, and when out-of-coverage for the transmission of the SL-PRS, the UE performs a second procedure of the transmission of the SL-PRS according to pre-configuration.

2. The UE according to claim 1, wherein:
in the first procedure, a resource for the transmission of SL-PRS is selected from a first resource pool which is indicated by the SystemInformationBlockTypeXX; and
in the second procedure, the resource for the transmission of SL-PRS is selected from a second resource pool which is indicated by the pre-configuration.

3. The UE according to claim 2, wherein:
in the first procedure, whether to perform the transmission of SL-PRS in the first resource pool further depends on a sensing result on the first resource pool.

4. The UE according to claim 2, wherein:
in the second procedure, whether to perform the transmission of SL-PRS in the second resource pool further depends on a sensing result on the second resource pool.

5. The UE according to claim 2, wherein:
in the second procedure, whether to perform the transmission of SL-PRS in the second resource pool further depends on whether to detect SidelinkSystemInformationBlockTypeXX from another UE.

6. The UE according to claim 2, wherein:
higher-layer processing circuitry is further configured to receive dedicated RRC configuration from a base station;
in the first procedure, when the dedicated RRC configuration is acquired, a resource for the transmission of SL-PRS is selected from a third resource pool which is indicated by the dedicated RRC configuration (and the first resource pool is not used).

7. The UE according to claim 2, wherein:
in the first procedure, whether to perform the transmission of SL-PRS depends on whether a list of system information described in SystemInformationBlockType1 (mentions) includes the SystemInformationBlockTypeXX.

8. A user equipment (UE) comprising:
higher-layer processing circuitry configured to receive SystemInformationBlockTypeXX (SL PRS related System Information Block) from a base station;
reception circuitry configured to perform a measurement of sidelink positioning reference signal (SL-PRS),
wherein
when the UE is in-coverage for the transmission of the SL-PRS, the UE performs a first procedure of the measurement of the SL-PRS according to SystemInformationBlockTypeXX, and when out-of-coverage for the transmission of the SL-PRS, the UE performs a second procedure of the measurement of the SL-PRS according to pre-configuration.

9. A method for a user equipment (UE), the method comprising:
receiving SystemInformationBlockTypeXX from a base station;
transmission circuitry configured to perform a transmission of sidelink positioning reference signal (SL-PRS),
wherein
when the UE is in-coverage for the transmission of the SL-PRS, the UE performs a first procedure of the transmission of the SL-PRS according to SystemInformationBlockTypeXX, and when out-of-coverage for the transmission of the SL-PRS, the UE performs a second procedure of the transmission of the SL-PRS according to pre-configuration.
